(19) United States
(12) Patent Application Publication
(10) Pub. No.: US 2015/0199450 A1
(43) Pub. Date: Jul. 16, 2015

(54) Systems and Methods for Associating User Sketches with Resources

(71) Applicants: Vyacheslav Elkin, Wilmette, IL (US); Scott Joseph Mcclain, Belvidere, IL (US)

(72) Inventors: Vyacheslav Elkin, Wilmette, IL (US); Scott Joseph Mcclain, Belvidere, IL (US)

(21) Appl. No.: 14/589,814

(22) Filed: Jan. 5, 2015

Related U.S. Application Data
(60) Provisional application No. 61/926,765, filed on Jan. 13, 2014.

(51) Int. Cl. G06F 17/30; H04L 12/58

(52) U.S. Cl. CPC G06F 17/30917; G06F 17/30873; H04L 51/04

(57) ABSTRACT

A first sketch defining a symbol absent from human writing systems is received along with a selection of an electronic resource to which the first sketch is to be mapped. A record is created in an electronic database, the record specifying the mapping between the first sketch and the electronic resource. Subsequently to generating the record, a second sketch is received via a user interface of a client device. A metric of similarity between the first sketch and the second sketch is determined. When the metric corresponds to a certain range of values, an indication of the mapping between the first sketch and the electronic resource is provided via the user interface of the client device, and a command is executed at the client device, using the electronic resource as a parameter.

### CROSS-REFERENCE TO RELATED APPLICATION

This application claims priority to U.S. Provisional Patent Application No. 61/926,765, filed on Jan. 13, 2014, and titled “Systems and Methods for Associating User Sketches with Resources,” the entire disclosure of which is expressly incorporated by reference herein.

### FIELD OF THE DISCLOSURE

This disclosure generally relates to referencing electronic resources and, more particularly, to associating electronic resources with user sketches.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In general, electronic resources such as web sites, email addresses, personal pages associated with social networks, etc. are identified using sets of alphanumeric characters, special characters such as exclamation marks or dollar signs, or other semantically meaningful symbols. Sometimes, these sets of semantically meaningful characters in turn form semantically meaningful words or phrases.

For example, resources on the World Wide Web are identified using so-called Uniform Resource Locators (URLs). A URL is basically a string of alphanumeric characters that specifies a host, a path on the host, and the name of the resource. For example, a resource on an Internet host can be identified as somehost.com/somepath/someresource.html, where somehost.com specifies the domain name of a host, somepath specifies a path on the host, and someresource.html specifies the name of the resource. To access the host identified by an alphanumeric string such as somehost.com, a client device operating in a computer network can contact a Domain Name Service (DNS) server. The client device transmits the alphanumeric string to the DNS server, and in response the DNS server provides an IP address such as 157.166.226.26, for example. Thus, DNS allows users to address hosts using semantically meaningful alphanumeric strings rather than difficult-to-remember combinations of numbers.

### SUMMARY

The techniques of this disclosure allow a user of a computing device to make a sketch with her finger, a stylus, or a mouse, etc., and map the sketch to an electronic resource, such as the website of her business or an email address, for example. The user can also specify whether she prefers to share the sketch and/or the mapping with everybody, only a limited group of people, or not at all, i.e., keep the sketch and/or the mapping private. A system implemented in a network, for example, can store the sketch along with an identifier of the corresponding resource in a repository implemented as a database or a flat file, for example. When this or another user enters another sketch and requests that the mapping of the sketch be determined, the system assesses similarity of two sketches by computing a pairwise Euclidean distance between vertices defining the sketches, or by generating another suitable quantitative metric of similarity. If the system determines that the sketches are sufficiently similar, the server confirms the selection of the resource and of the associated mapping and directs the user to the resource.

In this manner, users can identify and reference various electronic resources using sketches instead of, or in addition to, “traditional” alphanumeric URLs or other sequences of alphanumeric characters such as phone numbers. Further, some users can register domain names that do not include meaningful words or phrases and rely primarily on sketches for accessing these domains (e.g., a simple circle with a triangle inside the circle can direct users to a host with a non-intuitive and awkward name such as “www.asd23r432sdfasvc.com”). Still further, a user can utilize the techniques of this disclosure to create a symbolic vocabulary accessible only to herself or to a relatively small group of people, such as a group of friends.

More generally, the techniques of this disclosure allow users to create, share, and map sketches defining symbols that are not expressible through symbols already available in human writing systems. Some sketches may be generally recognizable or at least suggestive of a known object or activity (e.g., a fork, an envelope, an ice cream cone), while others may be more idiosyncratic (e.g., a circle and a triangle intersecting in a way that that is not meaningful to most people). When several users choose similar sketches, such that the system would generate a quantitative metric of similarity in a certain range indicative of a substantial match, map their respective sketches to different electronic resources, and choose to share the sketches and the mappings with overlapping groups of users, the system can prioritize the mappings based such factors as, for example, the chronological order in which the mappings were created or the monetary bid associated with the mapping. Further, in some implementations a mapping between a sketch and a resource can be limited to a certain geographic area.

As discussed in more detail below, a sketch can be made up a sequence of interconnected vertices or, in some implementations, of basic shapes such as rectangles, triangles, circles, ovals, etc., as well as straight lines, arcs, squiggly lines, etc. Moreover, a sketch in some cases can additionally include letters and numbers drawn by hand or typed. The system can compare sketches using any suitable technique, including those currently known in the art. For example, the system can re-sample a pair of sketches to define two equal-sized sets of points, iteratively select pairs of proximate points in the two sets, and calculate an aggregate distance between the two sets. In another implementation, the system can calculate distances between points on a stroke-by-stroke basis. In yet another implementation, the system can compare rasterized representations of sketches on a pixel-by-pixel basis. Moreover, when a sketch includes an alphanumeric component, the system first can compare the alphanumeric components of two or more sketches and, when there is a match, calculate similarity scores for the remaining portion of the sketch.

An example embodiment of the techniques of this disclosure is a method for mapping user sketches to electronic resources. The method can be executed on one or more processors. The method includes receiving (i) a first sketch defining a symbol absent from human writing systems along with (ii) a selection of an electronic resource to which the first sketch is to be mapped, and causing a record to be created in an electronic database, the record specifying the mapping between the first sketch and the electronic resource. The method further includes, receiving a second sketch via a user interface of a client device, subsequently to generating the record, and determining a metric of similarity between the first sketch and the second sketch. When the metric corresponds to a certain range of values, the method includes providing an indication of the mapping between the first sketch and the electronic resource via the user interface of the client device and causing the client device to execute a command using the electronic resource as a parameter.

Another example embodiment of these techniques is a method in a client device for accessing electronic resources, which also can be executed on one or more processors. The method includes providing a drawable region via a user interface of the client device, receiving a sketch entered via the drawable region, where the sketch is made up of a plurality of interconnected vertices, and receiving a request to determine a mapping of the received sketch to one or more electronic resources external to the client device. The method also includes transmitting, via a communication network, a data structure specifying respective coordinates of at least several of the plurality of interconnected vertices, receiving, via the communication network, a user-specified mapping between the received sketch and an electronic resource, based at least in part on similarity between the received sketch and a previously specified sketch mapped to the electronic resource, and executing a command associated with the electronic resource.

Yet another example embodiment of these techniques is a computing device having a user interface configured to receive graphic input, one or more processors, and a non-transitory computer-readable memory storing instructions. When executed on the one or more processors, the instructions cause the computing device to (i) receive, from a user in a first instance, a first sketch via the user interface and a mapping of the first sketch to an electronic resource, where the first sketch defines a symbol absent from human writing systems, and where the electronic resource identifies a target outside the computing device, (ii) receive, in a second instance, a second sketch via the user interface, and (iii) access the target in response to determining that the second sketch is similar to the first sketch.

### BRIEF DESCRIPTION OF THE DRAWINGS

FIG. 1A is a diagram that schematically illustrates a technique for “resolving” a user sketch into a domain name on a network server, in an example embodiment;

FIG. 1B is a diagram that schematically illustrates a technique for resolving a user sketch into an Internet Protocol (IP) address on a network server, in an example embodiment;

FIG. 1C is a diagram that schematically illustrates a technique for resolving a user sketch into a domain name on a client device, in an example embodiment;

FIG. 2A is a block diagram of an example communication system in which at least some of the techniques of processing user sketches at a server can be implemented;

FIG. 2B is a block diagram of an example communication system in which at least some of the techniques of processing user sketches at a client device can be implemented;

FIG. 3A is a block diagram of an example client device that can operate in the system of FIG. 2A and/or FIG. 3B;

FIG. 3B is a block diagram of an example software environment in which a software application processes user sketches, which can be implemented in the client device of FIG. 3;

FIG. 4 is a block of an example server that can operate in the system of FIG. 2A;

FIG. 5A depicts an example user sketch made up of several strokes, each represented by a sequence of points having a starting point and an end point, which can be mapped to a resource in accordance with the techniques of this disclosure;

FIG. 5B depicts an example user sketch made up of vertices on a discrete grid, which can be mapped to a resource in accordance with the techniques of this disclosure;

FIGS. 6A-E illustrate example transformation of a user sketch in accordance with Procrustes analysis to compare the user sketch with the sketch of FIG. 5B;

FIGS. 7A-D are example screenshots which the sketch processing application of FIG. 3B can generate when a user associates a new sketch with a resource;

FIGS. 8A-C are example screenshots which the sketch processing application of FIG. 3B can generate to identify resource(s) to which a user sketch appears to be mapped;

FIG. 9 is an example screenshot which the sketch processing application of FIG. 3B can generate to provide a listing of existing sketches and mappings available to the user;

FIG. 10A illustrates a user sketch that includes a non-alphanumeric shape as well as hand-drawn alphanumeric characters;

FIG. 10B illustrates a user sketch that includes a non-alphanumeric shape as well as typed-in alphanumeric characters;

FIG. 11A is a flow diagram of an example method for processing a user sketch, which can be implemented in the client device of FIG. 3A or 3B;

FIG. 11B is a flow diagram of an example method for requesting a new mapping between a user sketch and one or more resources, which can be implemented in the client device of FIG. 3A or 3B;

FIG. 11C is a flow diagram of an example method for determining a mapping between a user sketch and one or more resources, which can be implemented in the client device of FIG. 3A or 3B;

FIG. 11D is a flow diagram of an example method for processing a user sketch that includes a first component that represents a symbol inexpressible using human writing systems and a second component that represents a symbol that can be expressed using one or more human writing systems, which can be implemented in the client device of FIG. 3A or 3B;

FIG. 11E is a flow diagram of an example method for receiving a first sketch along with mapping parameters in a first instance and a second sketch in a second instance, and determining a possible mapping of the second sketch to an electronic resource, which can be implemented in the client device of FIG. 3A or 3B;

FIG. 12A is a flow diagram of an example method for registering a new resource, which can be implemented in the server of FIG. 4;

FIG. 12B is a flow diagram of an example method for determining the mapping between a user sketch and one or more resources, which can be implemented in the server of FIG. 4; and

FIG. 13 illustrates some of the example sketches which can be associated with individual businesses and/or categories of business;

### DETAILED DESCRIPTION

### I. Overview of Several Example Scenarios

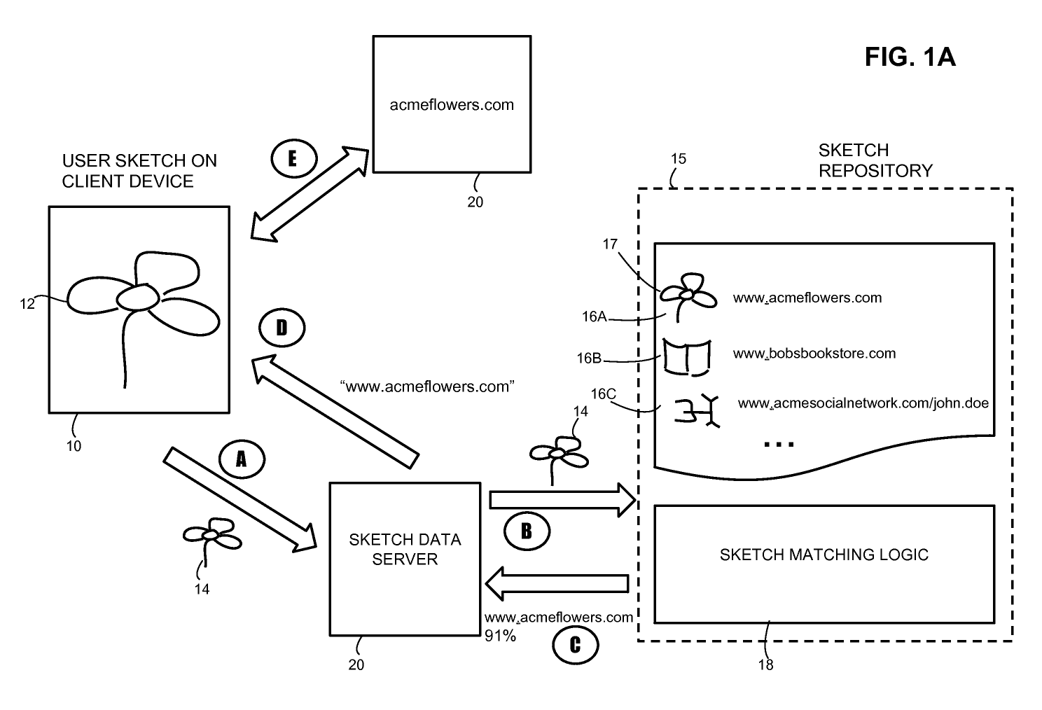

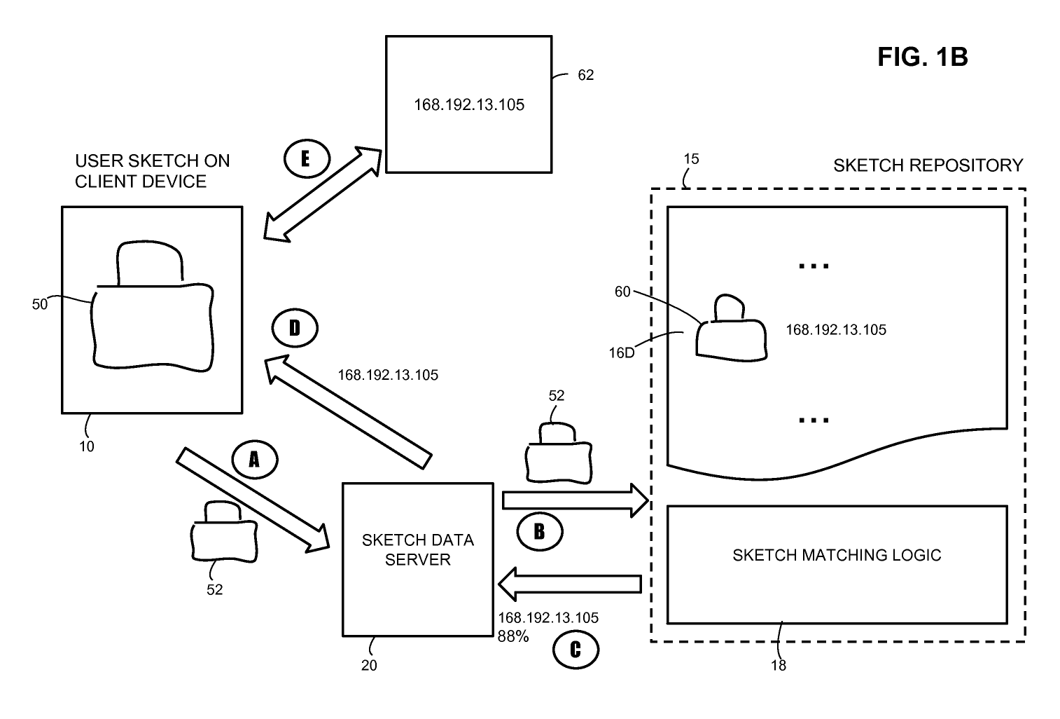

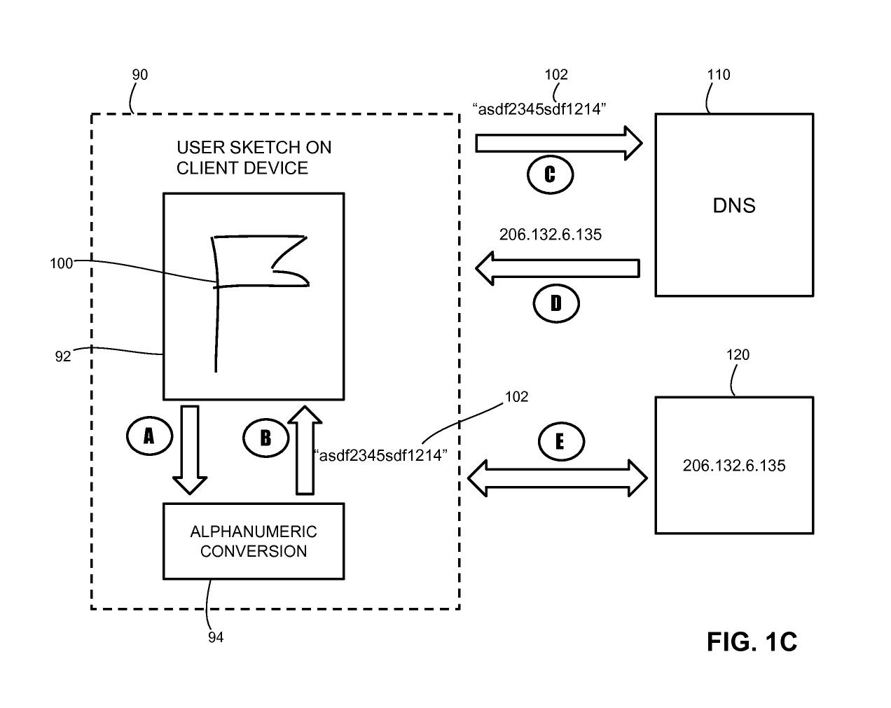

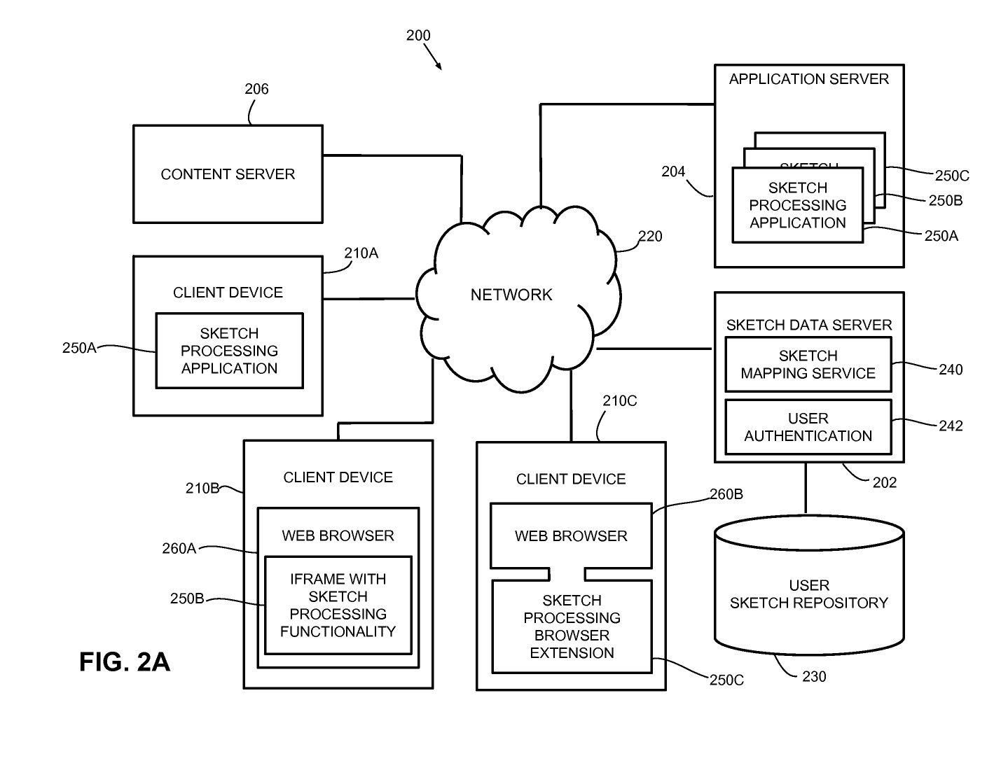

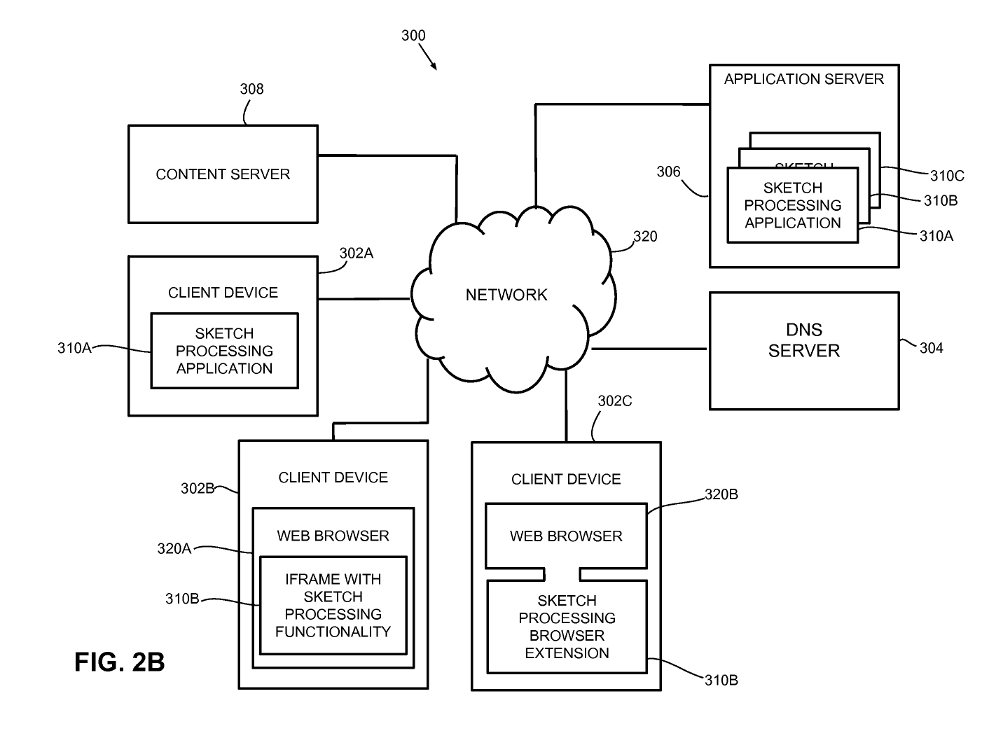

FIGS. 1A-C provide a high-level overview of several sketch mapping techniques of this disclosure. These and related techniques are then discussed in more detail with reference to FIGS. 2A-10.

Referring first to FIG. 1, a user in this scenario makes a sketch of a flower 12 on a touchscreen 10 using her finger, with five strokes: one for each of the three petals, one for the stamen (middle part of the flower), and one for the stem. A sketch processing module generates a sketch geometry description 14 which can include, for example, a specification of the “point cloud” that makes up the sketch or individual descriptions of the five strokes that make up the sketch 12. Each stroke description in turn can indicate a sequence of points on the touchscreen 10 covered by the corresponding stroke. In any case, the sketch geometry description 14 includes a direct (e.g., “vertex at 10, 20 connected to vertex at 30, 40, . . . . ”) or indirect (e.g., “a large circle adjacent to a small square, . . . ”) description of the geometry of the sketch 12. The sketch processing module then provides the sketch geometry description 14 to a sketch data server 20 (step A). For simplicity, geometry description can be referred to below as just “description.”

The sketch data server 20 then accesses a sketch database 15 (step B). The sketch database 15 stores records 16A, 16B, 16C, etc., each of which includes a description of a sketch and an identifier of a resource associated with the sketch. As discussed below, the sketch database 15 can store additional information for sketches, users, groups of users, etc. According to the example record 16A, the sketch 17 of a three-petal flower with a stem corresponds to web site www.acmeflowers.com. The example records 16B and 16C indicate that the sketch of an open book corresponds to web site www.bobsbooks.com, and the idiosyncratic sketch in the record 16C corresponds to the resource www.acmesocialnetwork.com/john.doe, which can be the web page of user John Doe on host www.acmesocialnetwork.com, for example. The sketch data server 20 may have created the records 16A-C in response to requests from the corresponding owners of resources www.acmeflowers.com, www.bobsbooks.com, and www.acmesocialnetwork.com/john.doe. For example, the owner of a flower shop may have decided, in addition to registering the domain name www.acmeflowers.com, to also map the sketch illustrated in the record 16A to the domain name www.acmeflowers.com. To this end, the owner may have entered the sketch 17 using a touch interface similar to the touchscreen 10.

A sketch matching logic module 18 compares the description 14 to the descriptions of sketches in the database 15 and generates corresponding similarity scores. The sketch matching logic module 18 then provides an indication to the sketch data server 20 that the description 14 corresponds to the web site www.acmeflowers.com, with 91% certainty (step C). In other words, the sketch matching logic module 18 determines that the similarity between the description 14 and the description of the flower in the record 16A can be quantified as a 91% match, and that none of the other descriptions of sketches in the database 15 produces a higher similarity score. As discussed in more detail below, the sketch matching logic module 18 can re-sample two sketches being compared, if necessary, and calculate a pairwise Euclidean distance between the points that make up the “point clouds” of the two sketches. Further, depending on the implementation, the sketch matching logic module 18 may consider the difference in orientation of two sketches being compared as meaningful or irrelevant.

The sketch matching logic module 18 then provides the resource indicator www.acmeflowers.com to the device that processes user input via the touchscreen 10 (step D), which in turn directs the user to host 20 with the domain name www.acmeflowers.com (step E). In this manner, the user accesses the web site www.acmeflowers.com without typing in the domain name. It is noted that the user's sketch 16 need not precisely reproduce every stroke of the sketch 17. Thus, when the user approximately sketches a three-petal flow with a stamen and a stem, the sketch matching logic module 18 will likely recognize that the user intended to make the sketch 17.

FIG. 1B illustrates a scenario that is generally similar to the scenario of FIG. 1A, except that in this case the user enters a sketch 50 resembling a shopping bag. The sketch data server 20 receives a description 52 of the sketch 50 and provides the description 52 to the sketch matching logic module 18, which in turn determines a 88% match between the description 52 and a description 60 in a record 16D. According to the record 16D, the description 60 corresponds to IP address “68.192.13.105.” Accordingly, rather than resolving the description 52 of the sketch 50 to a name of a host or resource, the sketch data server 20 resolves this description directly to an IP address and provides the IP address to the device at which the sketch was generated. Thus, in a sense, the sketch data server 20 here operates similarly to a DNS server.

FIG. 1C schematically illustrates another technique for associating user sketches with URLs and other resources. In this example, a client device 90 is equipped with a touchscreen 92 and implements an alphanumeric conversion module 94. After the user submits a sketch 100 (step A), the alphanumeric conversion module 94 generates an alphanumeric string 102 that represents a description of a canonical or “cleaned-up” form of the sketch 100 (step B). The client device 90 then provides the alphanumeric string 102 to a DNS server 110 (step C) to obtain IP address 206.132.6.135 (step D), using known DNS resolution techniques. The client device 90 then accesses host 120 with the IP address 206.132.6.135 (step E) to retreive content.

Referring generally to FIGS. 1A-C, it is noted that these techniques allow, for example, an operator of a host to register a domain name that cannot be represented as one or more symbols in human writing systems, and possibly is not semantically meaningful or memorable at all. In some cases, the operator may choose to not register a domain name for an IP address at all. Instead, the operator can rely on the sketch data server 20 and/or the the alphanumeric conversion module 94 to resolve sketches that are meaningful specifically to a user or groups of users. Some users may also find it useful to associate their personal web sites with symbols that only their friends know, so as to create the sense of exclusivity. It is further contemplated that operators who register domain names meaningful in one language can additionally associate these domain names with simple sketches that may be at least suggestive of a certain meaning to people who speak other languages (e.g., a fork or a cup).

When multiple people or business entities wish to associate their respective resources with a substantially same sketch, the sketch data server 20 can implement one or several of the following example strategies, depending on the embodiment: (i) completely prevent a later-in-time party from associating the sketch with its resource, (ii) partially prevent the later-in-time party by limiting the geographic area, social circle(s), etc. within which the sketch resolves to the later-in-time party's resource on a mobile device, or (iii) allow both mappings to co-exist by providing indications of multiple candidate resources in response to a request from a mobile device. Further, the sketch data server 20 in some implementations allows a user to negotiate the policy of resolving sketches potentially conflicting with the user's sketch. Thus, one user can request that strategy (i) be applied to her sketch, another user can select strategy (ii), etc. When strategy (iii) is chosen, the sketch data server 20 may prioritize the mapped resources according to various suitable principles, such as the chronological order in which resources were registered, for example.

Further, some sketches may be associated with multiple resources and/or actions (e.g., macros). For example, in one implementation, a user associates a sketch with a resource as well an one or several actions to be applied to the resource (e.g., fill-in text, submit a query).

### II. Example Computing Systems in which User Sketch Mapping can be Implemented

Several example systems in which the techniques discussed above can be implemented are discussed next. It will be understood, however, that in general these or similar techniques can be implemented in any suitable computing environment, and that the systems and devices of FIGS. 2A and 2B are provided by way of example only.

Referring first to FIG. 2A, a computing system 200 in the illustrated embodiment includes a sketch data server 202, an application server 204, a content server 206, and client devices 210A-C, interconnected via a communication network 220. The sketch data server 202 is coupled to a user sketch repository 230. Each of the servers 202, 204, and 206 can include one or several processors and one or several memory modules that store instructions, executable on the one or several processors, that implement the corresponding functionality. For ease of illustration, the servers 202, 204, and 206 are depicted in FIG. 2A as single network nodes. However, in some implementations, some of the servers 202, 204, and 206 are implemented as groups of servers. For example, the sketch data server 202 can be implemented as set of front-end servers configured to handle user requests and a set of back-end servers configured to compare sketches and generate similarity scores.

The communication network 220 can be any suitable local-area network or a wide-area network such as the Internet, for example. The communication network 220 can include any number of wireless and/or wireless communication links. In general, the servers 202, 205, and 206 and the client devices 210A-C can be interconnected using any suitable techniques, including those known in the art.

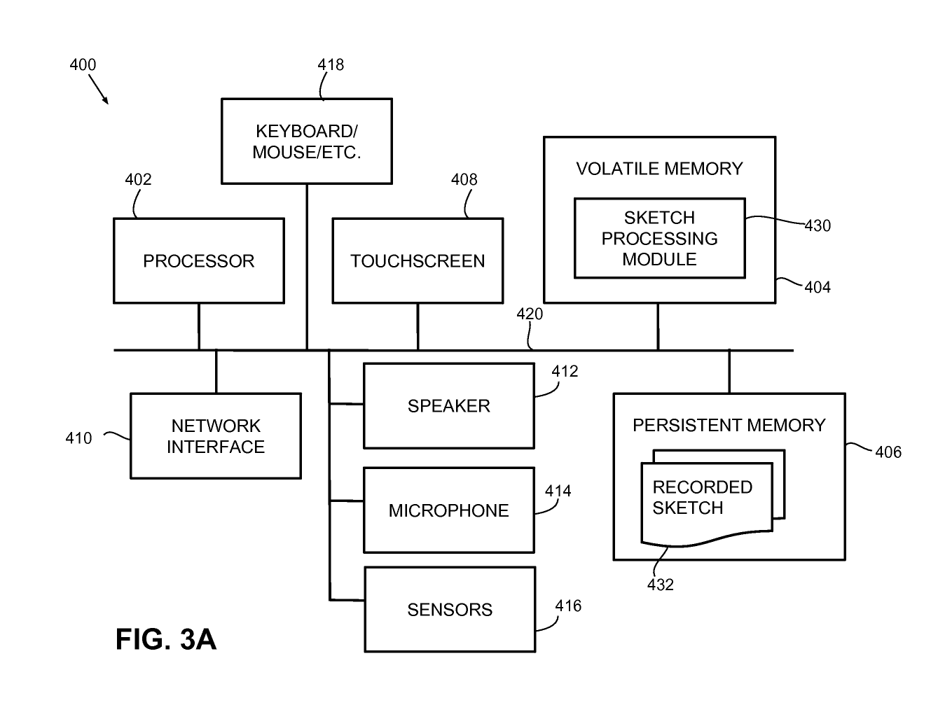

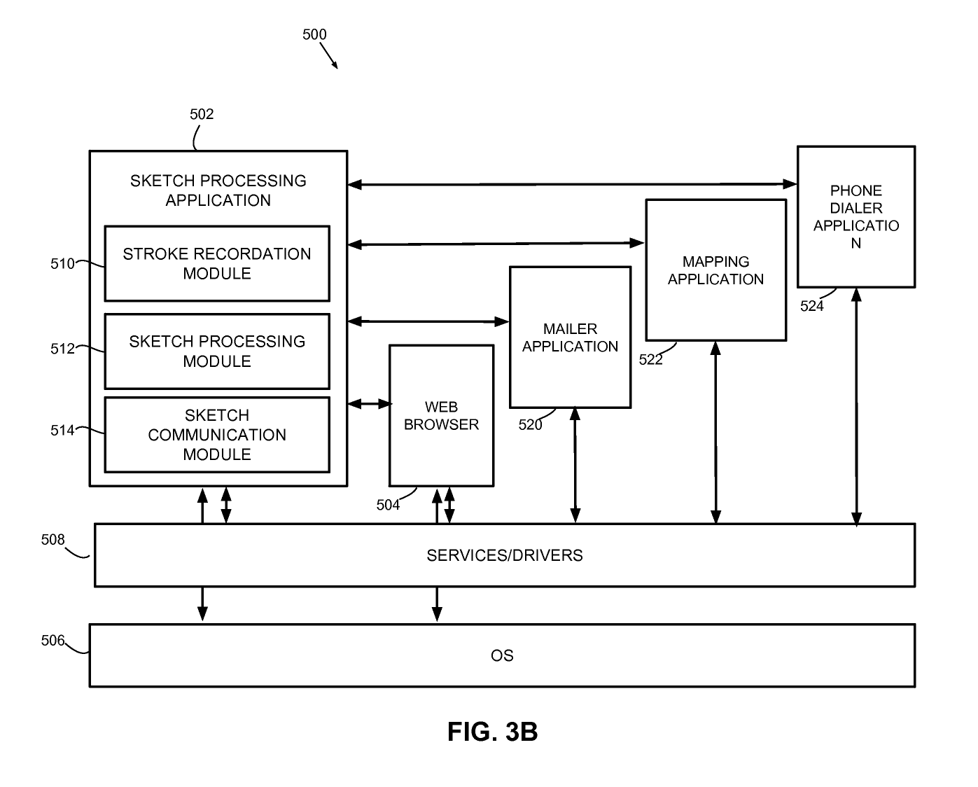

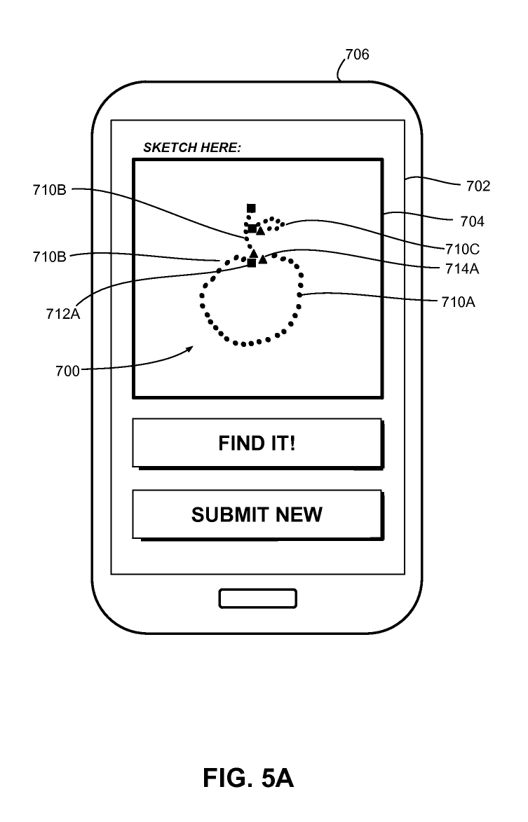

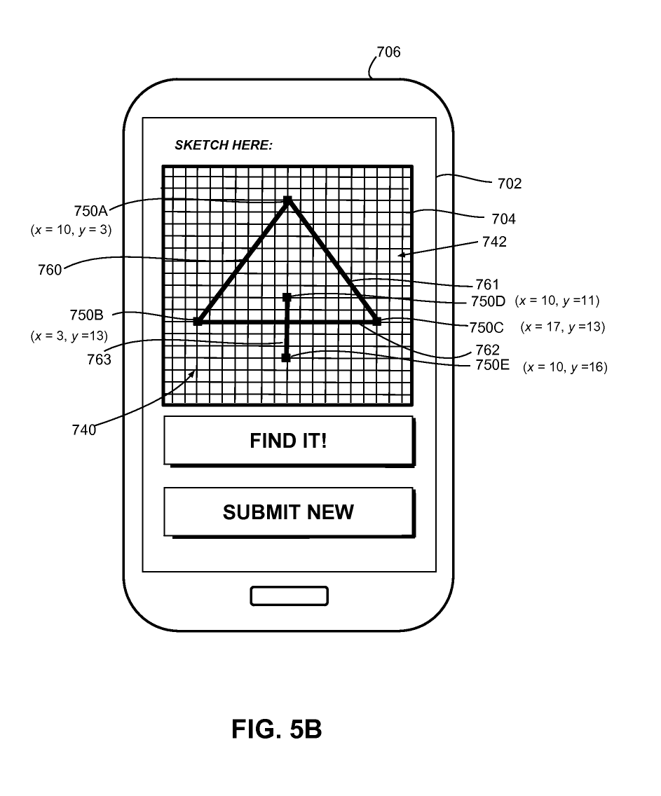

In one embodiment, the sketch data server 202 implements a sketch mapping service 240 that receives sketches from users, determines whether sketches are available for registration, creates new records in the user sketch repository 230, generates similarity scores for pairs of sketches, etc. The sketch mapping service 240 can be made up of any suitable number of software modules, implemented in any one or several programming languages. Example functionality of the sketch mapping service 240 is discussed in more detail below with reference to FIG. 3B and FIGS. 5A-E, for example.

The sketch data server 202 also can implement a user authentication module 242 to process user login and password, or other suitable authentication data. In some implementations and/or scenarios, users operating the client devices 210A-C provide authentication data to the sketch data server 202 to access their personal accounts. An example account can store indications of which sketches and mappings in the sketch repository 230 the user is authorized to access, how the user chooses to share his sketches with others, which background images the user likes to use, etc. The user authentication module 242 in some implementations can rely on an external server for authentication via an appropriate APIs. In this manner, users can login using their favorite social networks, email services, etc.

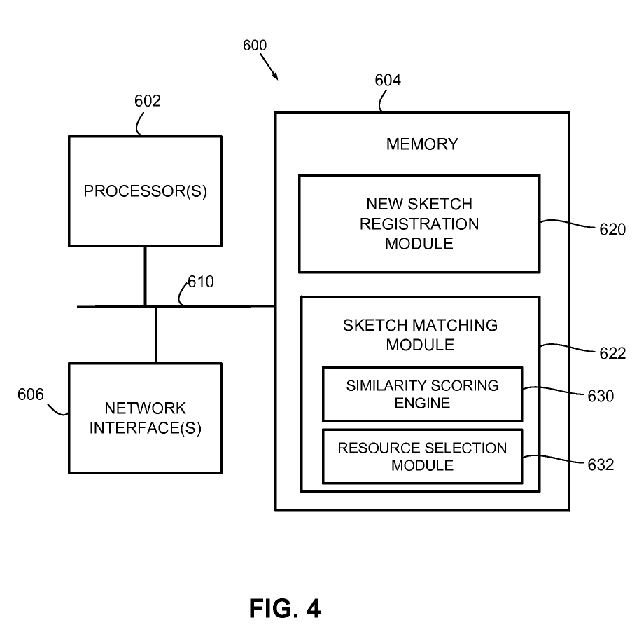

The sketch data server 202 and the user sketch repository 230 can be implemented in a single device/subsystem or different devices/subsystems, depending on the implementation, and interconnected in any suitable manner. As one example, the sketch repository 230 can be a relational database disposed in a dedicated server and accessible via Structured Query Language (SQL) instructions. Example records that can be stored in the user sketch repository 230 are discussed with reference to FIG. 4.

With continued reference to FIG. 2A, each of the client devices 210A-C can be any suitable user device equipped with a touchscreen, such as a smartphone, a tablet computer, a laptop computer, etc. In the client device 210A, a standalone sketch processing application 250A processes a sketch, generates a description of the sketch, provides the sketch to the sketch data server 202, receives descriptions of resources mapped to the sketch, etc. On the other hand, similar sketch processing functionality is provided in the client device 210B by an iframe 250B operating in a web browser application 260A, or otherwise as web page content. The client device 210C executes a similar web browser 260B, but in this example a browser extension or plugin 250C extends the functionality of the web browser 260B to provide sketch processing functionality. More generally, sketch processing functionality can be implemented in a client device as any suitable executable, library, instructions in a scripting language executable by another application, etc.

The application server 204 provides instances of the software modules 250A-C to client devices and/or web content servers. For example, a user can visit an online application store at a certain known URL, via which the user's device can access the application server 204 so as to download and install an instance of the sketch processing application 250A. In another scenario, a user of the client device 210B uses the web browser 260A to visit a web site maintained by the content server 206. The web browser 260A receives, from the the content server 206, content in the form of HTML instructions, Javascript instructions, etc., that also includes or references (at the application server) instructions for generating the iframe 250B. As yet another example, a user of the client device 210C operates the web browser 260B to download an instance of the browser extension 250C from the application server 204.

In some embodiments, the sketch data server 202, the application server 204, and the user sketch repository 230 make up a sketch mapping system administered by a single entity, although in general these components can operate, and be controlled, independently of each other. As used herein, the term “sketch mapping system” refers to any suitable configuration of hosts and tasks executing on these hosts which a client device can access via a computer network to use mapping between sketches and resources.

FIG. 2B illustrates another computing system 300 in which client devices 302A-C receive user sketches and determine which resources are mapped to these sketches, so that the user can automatically access these resources via a web browser or another application. However, unlike the client devices 210A-C discussed above, the client devices 302A-C determine which resources are mapped to user sketches without contacting a sketch data server or an online user sketch repository. Rather, each of the client devices 302A-C executes a software component that converts a user sketch into an alphanumeric string and submits a DNS query to a DNS server 304 via a network 320. After receiving a response to the DNS query, the client device accesses the resource mapped to the user sketch, such as the content server 308.

The client device 302A implements a standalone sketch processing application 320A, the client device 302B implements a web browser 320A that supports an inframe 310B, and a client device 302C supports a web browser 320B along with a browser extension 310B. An application server 306 provides the software modules 310A, 310B, and 310C to the client devices 302A, 302B, and 302C, respectively. Each of the software modules 310A-C converts user sketches to alphanumeric strings according to a certain principle. Thus, in a sense, client devices and servers operating in the computing system 300 agree on the manner in which user sketches are represented by alphanumeric strings, effectively extending the range of “useful” domain names available to individual users, businesses, various organizations, etc.

As a more specific example, the sketch processing application 320A can identify basic shapes within user sketches, with the basic shapes being limited to a relatively small set, such as a circle, a square, a triangle, a line, etc., as discussed further below with reference to FIG. 4. A sketch can correspond to a single basic shape or a combination of basic shapes. The sketch processing application 320A can map each basic shape to a certain string of alphanumeric characters. For example, a circle can correspond to “edg34,” a square can correspond to “dvj14,” a triangle can correspond to “sdf45,” etc. Thus, the sketch processing application 320A can map a sketch made up of a circle and a square, where the leftmost point on the circle is to the left of the leftmost point on the square (i.e., the circle can be considered to lie to the left of the square), to a URL formed by concatenating the strings “edg34” and “dvj14” to form “www.edg34dvj14.com” As one alternative, the sketch processing application 320A can order strings corresponding to component shapes to a predefined scheme rather than the arrangement of these shapes in the sketch (e.g., first listing the string for a circle as many times as the number of circles identified in the sketch, followed by the string(s) for one or more instances of the square, etc.). Whereas users would not find this string semantically meaningful, users can easily remember the geometric figure formed by placing a circle to left of a square. Thus, by consistently mapping a circle and a square arranged as discussed above to the same alphanumeric string, the sketch processing application 320A can effectively extend the set of usable and desirable URLs.

### III. Example Client Devices Providing Access to Resources Based on User Sketches

Now referring to FIG. 3A, one or more of the client devices 210A, 210B, 210C, 310A, 310B, or 310 discussed above can be implemented according to an example hardware configuration 400. The configuration 400 includes a processor 402, a volatile memory 404, a persistent memory 406, a user interface 408, a touchscreen 408, a network interface 410, a speaker 412, a microphone 414, and sensors 416. In some embodiments, the configuration 400 also includes a keyboard and/or a mouse 418 (and, more generally, other interface devices for receiving user input). These components are interconnected by a digital bus 420. For further clarity, components 402-420 are discussed below in more detail.

The processor 402 can be any suitable processor (e.g., a CPU) configured to operate in a portable device, a non-portable device, or both. In some implementations, a client device includes multiple instances of the processor 402. During operation, the processor 402 executes instructions stored in a computer-readable memory such as the memory component 404 or 406, for example.

The volatile memory module 404 can include, for example, random access memory (RAM), dynamic random access memory (DRAM), static random access memory (SRAM), or any other memory module that stores information while power is being supplied thereto. In some implementations, the volatile memory module 404 and one or more processors 402 are provided on a same chip. During operation of the client device, the volatile memory module 404 can store instructions that implement the operating system of the client device, various applications, services, drivers, etc., including a sketch processing module 430.

The sketch processing module 430 can include, for example, the sketch processing application 250A or 310A, instructions that generate an iframe 250B or 310B, or a sketch processing browser extension 250C or 310C. The sketch processing module 430 can include already-compiled instructions and/or instructions in one or several programming languages that are compiled or interpreted at runtime.

The persistent memory module 406 can include, for example, a hard disk, an optical disk, flash memory, etc. The persistent memory module 406 can store software instructions, parameters, configuration data, etc when no power is being supplied thereto. Further, the persistent memory module 406 in some cases can store one or more recorded sketches 432 in a format recognized by the sketch processing module 430, so that the user can quickly evoke and re-submit previously entered sketches. Still further, the persistent memory module 406 can store an instance of the sketch processing module 430, which is loaded into the volatile memory 404 during operation of the client device.

The touchscreen 408 can be of any suitable type (e.g., resistive, capacitive). The touchscreen 408 is configured to detect contact between its surface and the user's finger(s) and/or stylus. The touchscreen 408 can detect the coordinates at which contact occurs at a certain time and, in some embodiments, the pressure applied to the point of contact. The touchscreen 408 provides various parameters describing detected contact with the surface to the other components of the client device, such as the processor 402.

The network interface 410 can support short- and/or long-range communications, depending on the implementation. For example, the network interface 410 can support a fourth-generation (4G) wireless communication standard such as Long Term Evolution (LTE) to communicate using cellular communication links and/or an IEEE 802.11 (“WiFi”) communication standard to communicate via wireless local area network (WLAN) communication links. Further, the network interface 410 in some embodiments can support such protocols or WiFi-Direct® or Bluetooth® (IEEE 802.15) to communicate via wireless personal area network (WPAN) communication links. Still further, the network interface 410 in some embodiments can support the IEEE 802.3 protocol to communicate via wired LAN communication links. It will be noted, however, that these communication standards are provided above by way of example only, and that in general the network interface 410 can support any suitable communication standards, including those known in the art.

With continued reference to FIG. 3A, the sensors 416 can include, for example, an ambient light sensor, a proximity sensor, an accelerometer, a global or local positioning sensor, etc. Some of the sensors 416 can be provided as separate chips including components for computation and storage. In some implementations, the sensors 416 include one or more video cameras using which the device can detect three-dimensional (3D) “strokes” which define 3D shapes. Further, the sensors 416 in some implementations can be figured to detect and describe movement of the device in 3D space to define 3D shapes.

In other embodiments, a client device that can operate in the system 200 or 300 can include such additional components as a graphics processing unit (GPU) to efficiently render robust graphics content and one or several video cameras, for example. Further, a client device in some cases does not include some of the component illustrated in FIG. 3A. For example, a client device in one configuration has a hardware configuration generally similar to the hardware configuration 400 but, instead of the touchscreen 408, a mouse or another pointing device along with a screen that does not accept touch input. A user operating such a client device can generate sketches using the mouse.

Referring now to FIG. 3B, and with continued reference to FIG. 3A, the processor(s) 402 can execute an example software framework 500. Generally speaking, the software framework 500 can be implemented in a client device (e.g., client device 210A) to process user sketches and direct the user to resources to which these sketches are mapped.

A sketch processing application 502 (which can be similar to the sketch processing application 250A or 310A, for example) communicates with a web browser 504 using an application programming interface (API) exposed by the web browser 504. Both the sketch processing application 502 and the web browser 504 execute on an operating system (OS) 506 and access services and drivers 508. The sketch processing application 502 in this example includes a stroke recordation module 510, a sketch processing module 512, and a sketch communication module 514.

In operation, the OS 506 receives indications of contact with the touchscreen 408 and reports touchscreen events to the sketch processing application 502. The stroke recordation module 510 processes the touchscreen events to describe a user sketch in terms of individual strokes that make up the sketch, in an embodiment. According to this approach, each stroke has a starting point (the point at which user's finger or stylus first touched down on the surface), several intermediate points, and an end point (the point at which user lifted her finger or the stylus off the surface). The number of intermediate points reported along the path from the starting point to the end point can depend on such factors as parameters (e.g., resolution) of the touchscreen 408, the implementation of the OS 56, the configuration of the API used to retrieve touch screen events from the touchscreen 408, etc.

For each stroke, the stroke recordation module 510 can determine the starting point, the end point, and a set of sketch points collected along the trajectory of the stroke according to a certain scheme. The stroke processing module 512 then can format the descriptions of individual strokes into a single XML file, for example. As a more specific example, a user sketch can be described in the following format:

```
<Sketch>
        <Stroke num= n1>
            <Point X= x1 Y = y1>
            <Point X = x2 Y = y2>
        ...
        <Point X = xM Y = yM>
        </Stroke>
    <Stroke num= n2>
            <Point X= x1′ Y = y1′>
            <Point X = x2′ Y = y2′>
        ...
        <Point X = xL′ Y = yL′>
        </Stroke>
        <Stroke num= n2>
        ...
        </Stroke>
        ...
</Sketch>
```

According to this format, the point with coordinates (x1, y1) is the starting point of the first stroke, the point with coordinates (x2, y2) is the next point in the first stroke, and the sequence of points that make up the first stroke continues until the point with coordinates (xM, yM), which is the last point of the first stroke. Similarly, the point with coordinates (x1′, y1′) is the starting point of the second stroke, the point with coordinates (x2′, y2′) is the next point in the second stroke, and the sequence of points that make up the second first stroke continues until the point with coordinates (xL′, yL′), which is the last point of the the second stroke. The strokes need not not be of the same length, and thus M can be equal or not equal to L. A description of the sketch can include any desired number of strokes (e.g., 1, 2, 10).

Depending on the implementation, a description of a point can include additional information such as a timestamp, an indication of pressure, etc. Further, in some embodiments, a description of a stroke also include an indication of color of the stroke, an indication of line thickness, etc.

In another implementation, the stroke recordation module 510 describes the user sketch as a collection points in a two-dimensional space, with no regard to the strokes with which these points were associated in the original user input. Thus, if a user draws a circle with two strokes as two arcs in a first instance, and with a single stroke in a second instance, the descriptions of the two sketches may be very similar. A user sketch in this implementation can be described in the following format:

```
<Sketch>
    <Point X= x1 Y = y1>
        <Point X = x2 Y = y2>
    ....
    <Point X = xN Y = yN>
</Sketch>
```

If desired, this format also can include indications of whether pairs of adjacent points are connected or disconnected. For example, the points with the coordinates (x1, y1) and (x2, y2) can belong to the same stroke, whereas the points with the coordinates (x2, y2) and (x3, y3) can be belong to different strokes.

The stroke recordation module 510 can use the same sampling number N (e.g., N=40) for all sketches. As a result, a relatively simple sketch and a relatively complex sketch can be described using the same N points in a two-dimensional space. As discussed in more detail below, this approach can make sketch comparison more efficient.

Still further, in addition to describing strokes that make up the sketch, the XML file can indicate whether the sketch also includes alphanumeric characters entered in a conventional manner, e.g., via a keyboard or speech-to-text recognition. When alphanumeric characters are present, the XML file can specify the alphanumeric characters as well as the position, font, color, etc. of these characters. Moreover, the XML file can include additional information such as a text label the user may wish to assign to the sketch, sharing parameters, etc.

In some implementations, the stroke recordation module 510 allows users to draw over predefined or uploaded background images. The background image can be, for example, music paper (a single five-line stave or multiple staves). As a more specific example, a certain user can configure the sketch processing application 502 to display a single stave as the default background. The user can associate individual notes, short sequences of notes, chords, etc. with various resources. Depending on the embodiment, the user can choose to include the background image as part of the sketch or omit the background image. Thus, when the user chooses to include the background stave, an individual eighth note A will be treated differently from an individual eighth note C for the purposes of sketch matching, by virtue of being placed between different pairs of ledger lines, even when the two note symbols are sketched very similarly. On the other hand, when the user chooses to omit the background stave, an individual eighth note A will be treated similarly to an individual eighth note C for the purposes of sketch matching, when the two note symbols are sketched similarly. Further, depending on the embodiment and/or whether the user chooses to omit or include the background image, the background image is sent or not sent to the server.

The sketch communication module 514 transmits a description of the sketch via the network interface 410 to a network server such as the sketch data server 202, in one embodiment. In response, the sketch communication module 514 receives, via the network interface 410, an indication of a resource mapped to the sketch. The indication can include a domain name, an IP address, a URL, an email address, a telephone number, etc. The sketch communication module 514 then launches an instance (or a new window) of the web browser 504 or passes the indication of the resource to the already-running web browser 504. The web browser 504 then fetches the resource and displays the resource via the touchscreen 408, for example.

In an alternative embodiment, the sketch processing module 512 transforms the description of the sketch into an alphanumeric string locally, without transmitting the description to a network server. In this case, the sketch processing application 502 can provide the alphanumeric string directly to the web browser 504 or, alternatively, can submit a DNS query and process the response using the sketch communication component 514. The sketch processing application 502 then can provide the IP address to the web browser 504.

The sketch processing application 502 can similarly communicate with other software applications such as a mailer application 520, a mapping application 522, a phone dialer application 524, an instant messaging application (now shown to avoid clutter), etc. For example, the sketch communication module 514 can receive an email address from the sketch data server 202, invoke the mailer application 520, and automatically launch a window for composing a new email to the email address. In some embodiments, the mapping of the sketch can specify not only an email address but an at least partially composed message (e.g., a template for a thank-you letter to follow up on a job interview, a template for a holiday greeting, etc.). In other embodiments, the mapping of the sketch can specify only the text for use with an email message, without specifying a particular address.

When the sketch communication module 514 receives an indication of a geographic location, the sketch processing application 502 can launch a mapping application 522 with the indicated location as a parameter. Further, when the sketch communication module 514 receives a telephone number from the sketch data server 202, the sketch processing application 502 can launch a phone dialer application 524 with the indicated phone number as a parameter.

### IV. Example Servers that Support Mapping of Sketches to Resources

FIG. 4 illustrates an example server 600 which can operate in the system 200 as the sketch data server 202, for example. The server 600 includes one or more processors 602, a memory 604 including one or more volatile memory modules and/or one or more non-volatile memory modules, and a network interface 606, interconnected via a digital bus 610. The memory 604 stores instructions that implement a new sketch registration module 620 and a sketch matching module 622. The modules 620 and 622 can operate as part of a sketch mapping service, such as the sketch mapping service 240 of FIG. 2A.

In operation, the new sketch registration module 620 receives, from client devices, descriptions of sketches via the network interface 606 along with indications of resources to be mapped to these sketches. The new sketch registration module 620 accesses a sketch database, such as the user sketch repository 230, to store the new sketch and the resource. For example, a database table storing descriptions of sketches and a table storing indications of resources can be updated. For further clarity, Table 1 below lists several database fields that can be associated with a user sketch. Depending on the implementation, these fields can be provided in one table or multiple tables linked in accordance with relational database principles, for example.

TABLE 1

| FIELD | DESCRIPTION/PURPOSE |
|---|---|
| Sketch identifier | Unique numerical identifier assigned to a sketch. This identifier may |
| | be used to logically link database tables and facilitate searches, for |
| | example. The identifier may not be exposed to the user. |
| User identifier | Unique numerical identifier of the user who created the sketch. This |
| | identifier may serve as an index to a table storing detailed user |
| | information (e.g., name, address). |
| Sketch Name/Title | A (typically brief) textual description of the overall sketch, e.g., “Joe's |
| | Flower Shop,” or simply “flowers.” |
| Sketch Family | A coding scheme which can be used to quickly identify sketches that |
| | are similar before starting finer-granularity recognition. For example, a |
| | certain family can be “name & shape,” in which every sketch includes |
| | an alphanumeric string (with which the search may begin) and an |
| | enclosing, overlapping, abutting, proximate, etc. shape. In some |
| | implementations, such as those based on comparing point clouds, this |
| | field may not be used at all. |
| Sketch Description | A set of points and/or standard shapes defining sketch geometry. The |
| | sketch can be made up of one or several strokes, each including a set of |
| | points. In addition to the stroke(s), the description can specify the |
| | presence of text in the sketch and various properties of the text. |
| Sketch Image | A binary description, or a link to a binary description, of the user |
| | sketch in a standard digital image format, such as PNG. |
| Time of creation | A timestamp to indicate when the sketch was created. |
| Number of | The number of resources associated with a user sketch. In many cases, |
| associated | the number is one. However, a sketch in general can be associated with |
| resources | multiple resources. The next two fields are specified for each resource. |
| Associated resource | Type of a resource mapped to the sketch, such as domain name, IP |
| type | address, site URL, email address, etc. |
| Associated resource | An identifier of the resource mapped to the sketch. The identifier can |
| | be, for example, a URL. |
| Temporal | An indication of how long the mapping is to remain valid (e.g., |
| restrictions | indefinitely, one month, one year). |
| Spatial restrictions | An indication of where the mapping is valid (expressed, for example, in |
| | terms of a zip code, a radius, etc.). |
| Social restrictions | An indication of which users should have access to the mapping: only |
| | the user (no sharing), a certain group (e.g., “the friend circle”), all |
| | users. In some scenarios, the owner of the sketch may choose to share |
| | the sketch but not the mapping. |
| Allowable | Numeric value indicating how accurately the user must draw the sketch |
| Recognition | to determine a possible match. When the user does not specify the |
| Tolerance | value, a default value (e.g., 90% can be automatically provided). |
| Additional message | Message to be provided to the client device along with the resource |
| | identifier. |

It is noted that the fields above are provided by way of example, and that some of these fields may not be used in every implementation or, conversely, some implementations may include additional fields.

Moreover, as discussed in more detail below, some of the fields discussed above can be formatted and used according to a particular technique used to describe sketches, resources, etc. As one example, if the user sketch is described in terms of vertices rather than in terms of strokes, the field Sketch Description can store a linked list of vertices and descriptions of lines interconnecting these vertices. As another example, the sketch in a certain implementation can be described in terms of standard shapes, such as “a square with sides 7 centered at (10, 25) and a circle of radius 10 centered at (10, 23). Further, the alphanumeric part of a sketch in some embodiments can be stored and managed separately to enable look-up based first on text and then on the nontextual part of the sketch.

The new sketch registration module 620 also can create and update records specific to users. Similar to the records discussed above with reference to Table 1, these records can be stored in a sketch database, such as the user sketch repository 230 of FIG. 2A. Table 2 below illustrates several example database fields of user-specific records:

TABLE 2

| FIELD | DESCRIPTION/PURPOSE |
|---|---|
| User Identity | A sufficiently unique identifier of the user. In some |
| | implementations of the system, users can be |
| | authenticated using various email services, social |
| | networks, messaging services, etc. |
| Authentication | Authentication method. As indicated above, the system |
| method | can implement its own user authentication mechanism, |
| | or can use authentication services of other services. |
| Background | Background(s) against which the user prefers to sketch. |
| preferences | |
| Other | Preferences related to sketching (e.g., color), mapping |
| preferences | (e.g., “search for matching sketches only among user's |
| | own sketches,” “search for matching sketches among |
| | user's own sketches and the shared friends' sketches,” |
| | “always ask for confirmation before accessing the |
| | resource to which the matching sketch is mapped,”), etc. |
| Sketches | References to one or more sketches the user created |
| | and/or is authorized to use. These references may be the |
| | sketch identifiers listed in Table 1 above. |

The sketch matching module 622 can receive a request from a client device (such as the client device 210A, 210B, or 210C) to match a description of a user sketch entered at the client device to one of the descriptions of sketches already stored in the user sketch repository. Depending on the implementation, the sketch matching module 622 can compare the received sketch to every sketch in the repository or a subset of the sketches. For example, if the client device is interested only in resources mapped to the sketch of a fork in his zip code, the sketch matching module 622 can compare the received sketch to only those sketches that include this zip code as a spatial restriction. More generally, descriptions of sketches can be organized and stored in an efficient manner that allows the sketch matching module 622 to find a match between the received sketch and a stored sketch without comparing the received sketch to every sketch in the repository.

The sketch matching module 622 includes a similarity scoring engine 630 configured to generate a score (or, more generally, a metric) of similarity between a pair of sketches. In an example embodiment, the sketch matching module 622 implements the multistroke recognition algorithm described in Anthony, L. and Wobbrock, J. O., “$N-Protractor: a Fast and Accurate Multistroke Recognizer,” Proceedings of Graphics Interface (GI '12). Toronto, Ontario (May 28-30, 2012). Toronto, Ontario: Canadian Information Processing Society, pp. 117-120. In another embodiment, the sketch matching module 622 implements the algorithm described in Vatavu, R., Anthony, L and Wobbrock, J. O., “Gestures as Point Clouds: a $P Recognizer for User Interface Prototypes,” Proceedings of the 14th ACM International Conference on Multimodal Interaction, pp. 273-280. In yet another embodiment, the sketch matching module 622 implements the gesture recognition algorithm described in Li, Y, “Protractor: A fast and Accurate Gesture Recognizer,” Proceedings of the ACM Conference on Human Factors in Computing Systems (CHI '10) (Atlanta, Ga. (Apr. 10-15, 2010). New York: ACM Press, pp. 2169-2172). These articles are hereby incorporated by reference herein.

In another implementation, the sketch matching module 622 can implement a technique that involves recognizing shapes from among a relatively small set, or “vocabulary,” such as {triangle, rectangle, circle, line, ellipse, diamond}. For example, one such technique is described in Jorge, J. A. and Fonseca, M. J., “A Simple Approach to Recognize Geometric Shapes Interactively,” Selected Papers from the Third International Workshop on Graphics Recognition, Recent Advances, pp. 266-276. The sketch matching module 622 can recognize, within a sketch, one or more shapes from the vocabulary, determine relative positioning of these shapes, generate a description of the sketch as a collection of shapes disposed in a certain manner relative to each other. The sketch matching module 622 then can compare respective descriptions of sketches to generate a similarity metric.

Other possible techniques the sketch matching module 622 can implement can include, for example, on comparing pairs of sketches based on a sequence of vertices disposed on a grid of a certain limited resolution.

Generally speaking, the sketch matching module 622 implement a suitable algorithm for comparing sketches, to generate a similarity score indicative of how similar a description of a sketch received from a client device is to a description of a sketch already stored in a sketch repository.

The sketch matching module 622 also includes a resource selection module 632 configured to select a sketch from among several potential matches based on similarity scores and, in some cases, temporal, spatial, and/or social/social networking restrictions. For example, the similarity scoring engine may determine that a user sketch S has a similarity score of 90% with respect to sketch S1, a similarity score of 88% with respect to sketch S2, and a similarity score of 88% with respect to sketch S3. The resource selection module 632 may analyze various restrictions associated with sketches S1, S2, and S3, and select a sketch that conforms to all the restrictions and has a high similarity score.

Depending on the implementation, the sketch matching module 622 can provide only the sketch with the best score to the client device (along with the corresponding resource mapping information) or a certain number of sketches (e.g., 3, 5) with top similarity scores. In the latter case, the client device can rank and display the sketches via the user interface in accordance with the similarity scores.

### V. Example Input of a Sketch Via a Touchscreen Client Device

FIG. 5A illustrates an example sketch 700 entered via a touchscreen 702 of a portable client device 706. A sketch processing module executing on the client device 700 (which may be similar to the sketch processing module 430 discussed above) allocates a drawing region 704 within which the user can sketch using her finger or stylus. In this example, the user enters strokes 710A-C. For example, stroke 710A begins at start point 712A and ends at end point 712B, as denoted by a square and a triangle, respectively. It will be understood that these symbols are used in FIG. 5A for clarity only, and that the sketch processing module need not visually emphasize start and end points using these or other symbols.

Each stroke 710A-C includes several points disposed along the path of the user's finger, stylus, etc. from the start point 712A to the end point 712B. Although the sketch processing module may display strokes as continuous trajectories of a finger or stylus on the touchscreen 702 in response to user input, the sketch processing module may select some of the points to describe the sketch 700. The spacing between successive points can be implementation-specific. Further, to make a description of the sketch 700 more compact (and therefore easier to store, transmit, etc.), the sketch processing module can impose additional restrictions, such as a limit on the number of points recorded between the start point 712A to the end point 712B. For example, the sketch processing module may require that each stroke be made up of 20 points or less. More generally, the number of discrete points that make a stroke can be configured in any desired manner. Moreover, the sketch processing module in some scenarios re-samples individual strokes or the entire sketch to generate a certain pre-determined number N of points, as the sketch is being entered or after the sketch has been entered.

Further, the order of the strokes 710A-C may be used to distinguish drawings in some embodiments. For example, the XML file can specify the order and/or the relative time at which a stroke was entered. Thus, in one contemplated embodiment, a user can require that the strokes be timed in a certain way to access a resource. In other embodiments, the order and/or the timing of the strokes 710A-C does not affect comparison of pairs of user sketches.

FIG. 5B illustrates an alternative approach to describing user sketches, which can be implemented in the sketch processing module discussed above or a similar software module. In this case, the user draws a sketch 740 on a grid 742, which may be visible or invisible to the user, depending on the embodiment. The sketch 740 in this example includes vertices 750A-D which may expressed as discrete coordinates (x, y) on the grid 742. As a more specific example, the upper right corner of the drawing region 704 can be associated with coordinates (0, 0), and the coordinates of the vertex 750A can be (10, 3), the coordinates of the vertex 750B can be (3, 13), the coordinates of the vertex 750C can be (17, 13), etc. In some implementations, the sketch processing module can automatically “snap” a vertex to the nearest discrete coordinate. The vertices 750A-D in this implementation are interconnected with straight lines 760-763.

In one implementation, the user may define the sketch 540 by clicking on points on the grid 742 to select vertices and actuating a certain line control, such as a button (not shown), to connect the vertex entered last to the second-to-last vertex. When the user does not actuate the control between specifying two successive vertices, no line is drawn. As a more specific example, the user can draw the shape 740 by (i) specifying vertex 750A, (ii) specifying vertex 750B, (iii) actuating the control to connect vertices 750A and 750B, (iv) specifying vertex 750C, (v) actuating the control to connect vertices 750B and 750C, (vi) specifying vertex 750C again, (vii) actuating the control to connect vertices 750C and 750A, (viii), specifying vertex 750D, (ix) specifying vertex 750E (without actuating the control to avoid creating a line connecting vertices 750A and 750D, and (x) actuating the control to connect vertices 750D and 750E.

Thus, user input thus can be entirely point-based rather than stroke-based in this implementation.

In another implementation, however, the user draws the sketch using strokes, and the sketch processing module snaps the endpoints of these strokes to discrete vertices on the grid 742. Additionally, the sketch processing module can detect and snap vertices where the stroke significantly changes direction (e.g., by 60 or less degrees or 120 or more degrees). Thus, if the user draws the triangle defined by vertices 750A-C using a single stroke (i.e., without lifting off his finger or stylus), the sketch processing module can still identify vertices 750A-C.

In any case, the triangular portion of the sketch 740 can be described in terms of the coordinates of the constituent vertices and either implicit or explicit indications of the interconnecting lines. For example, the triangular portion of the sketch 740 can be described as a list {(10, 3), (3, 13), (17, 13), (10, 3)}. The vertical line connecting vertices 750D and 750E can be described as a list of coordinates {(10, 11), (10, 16)}. Thus, the sketch 740 can be described and stored as {{(10, 3), (3, 13), (17, 13), (10, 3)}, {(10, 11), (10, 16)} }.

To compare the sketch 740 to another sketch this or another user can submit (“a candidate sketch”), the sketch processing module can implement a statistical shape analysis techniques such as Procrustes analysis, for example. Generally speaking, this type of analysis can include optimal translation, rotation, and uniform scaling of the candidate sketch to generate a transformed candidate sketch. The set of vertices that defines the transformed candidate sketch then can be superimposed onto the set of vertices that defines the sketch 740. The sketch processing module then can calculate Euclidean distances between corresponding vertices in the two sets to produce a quantitative metric of how similar the sketch 740 and the candidate sketch are.

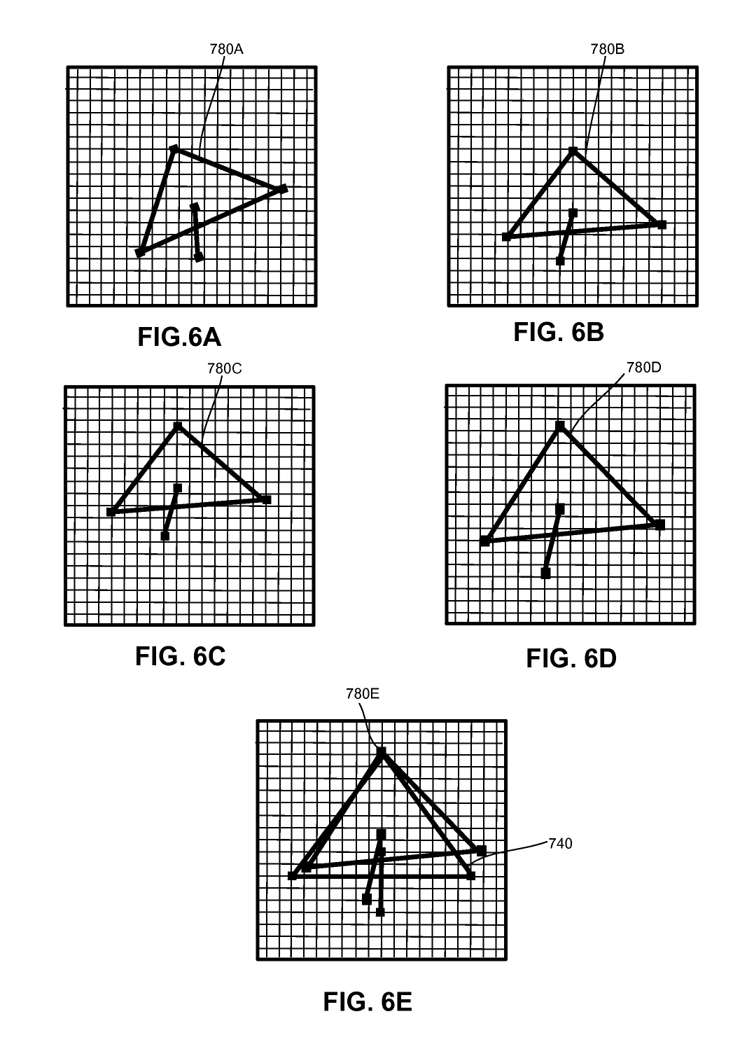

For example, referring to FIG. 6A, a user can submit a sketch 780A which clearly resembles the sketch 740 of FIG. 5B, but appears smaller, less symmetrical, and tilted to one side. The sketch processing module can execute a rotation operation to generate a sketch 780B (FIG. 6B), a translation (move) operation to generate a sketch 780C (FIG. 6C), and a scaling operation to generate a sketch 780D (FIG. 6D). It is noted that these operations need not occur in the order illustrated in FIGS. 6A-E.

The resulting sketch 780E can be superimposed on the sketch 740, and distances between corresponding vertices in the two sets can be calculated and compared to one or several threshold values (FIG. 6E). In an embodiment, the sketch processing module implements the approach described in C. Goodall, “Procrustes Methods in the Statistical Analysis of Shape” in Journal of the Royal Statistical Society, Series B (Methodological). Vol. 53, No. 2 (1991), pp. 285-339.

Other suitable input techniques the sketch processing module can implement include providing a set of simple shapes for use as building blocks. For example, the sketch processing module can automatically match each newly entered stroke to one of a square, a triangle, a circle, a line, so that every user sketch is a certain arrangement of one or more squares, one or more triangles, one or more circles, and one or more lines. For simplicity, the sketch processing module can recognize a single size for each component shape, or a small set of sizes (e.g., small, medium, large). The sketch processing module can describe an example idiosyncratic arrangement as a small square, a large circle to the right of the square, and a small line under the small square. If desired, the sketch processing module can utilize a more precise scheme for specifying placement of shapes relative to each other, such as specifying the coordinates of the centerpoint of a component shape. In some implementations, the sketch processing module can provide dedicated controls for adding the standard shapes to the sketch (e.g., a button for adding a circle).

### VI. Examples of User Interface Screens

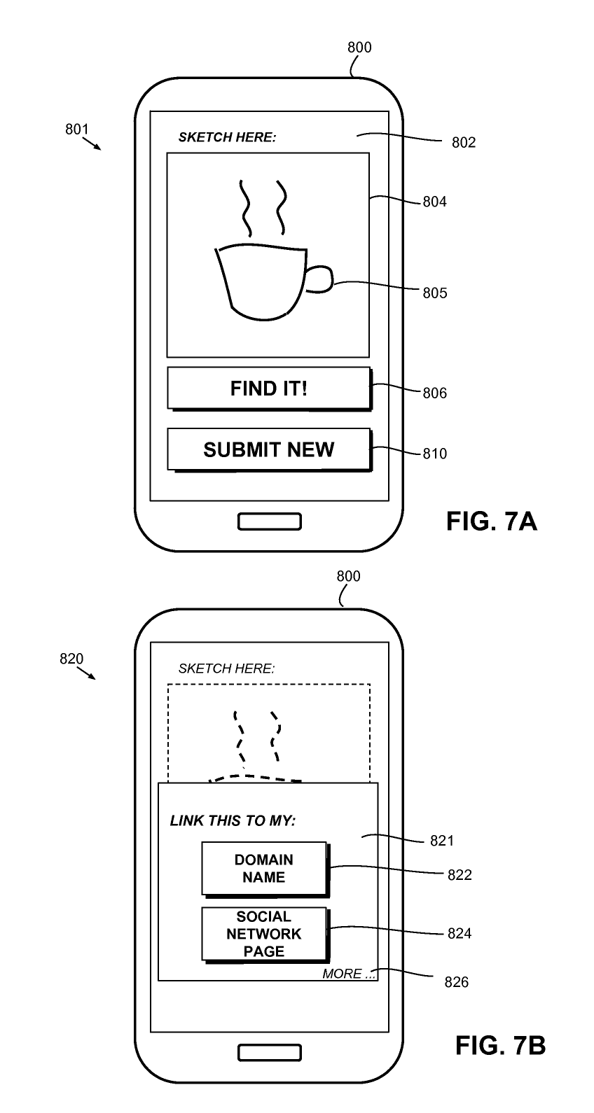

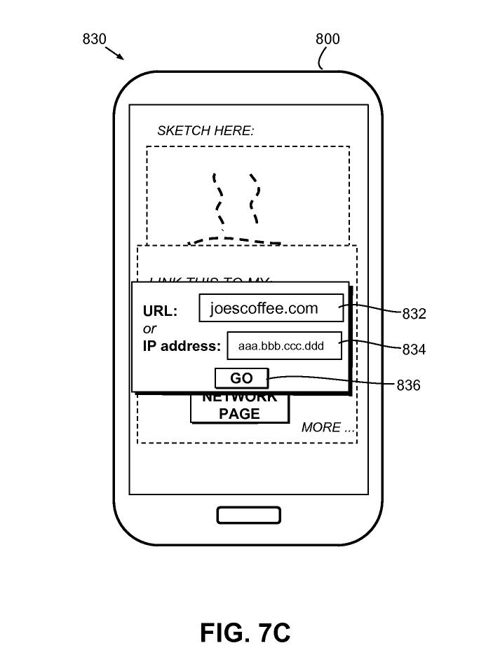

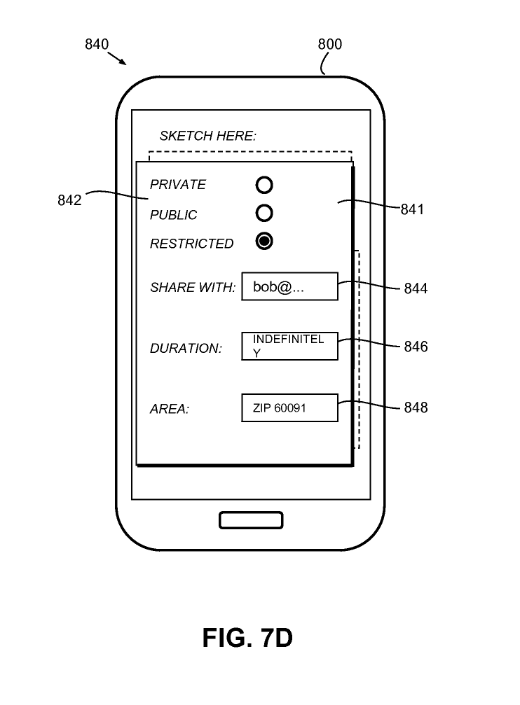

For further clarity, several example UI views of the sketch processing application 250A running on a portable device 800 are discussed next with reference to FIGS. 7A-9 and again to FIG. 2A. It will be understood that browser extension-based and iframe-based implementations of the sketch processing module for portable or non-portable devices can implement similar views or other views for receiving user sketches, submitting user sketches, etc.

Referring first to FIG. 7A, the sketch processing application 250A can generate a UI view 801 including a prompt 802 to display an instruction for the user; a drawable region 804 for receiving a user sketch as a set of strokes, a set of vertices, or in any other suitable manner; a button 806 for submitting a query including a sketch; and a button 810 for submitting a new user sketch, to be associated with a resource. In some implementations, the UI view 801 includes additional screens and controls (e.g., controls for activating a screen via which the user can supply his identity and password, specify temporal, spatial, and/or social/social networking restrictions, or configure various preferences).

After the user completes a sketch 805 and actuates the button 810, the sketch processing application 250A can transition to a UI view 820 illustrated in FIG. 7B. This view includes a screen 821 that allows the user to select one or several types of resources via buttons 822 and 824 (in this case, a domain name and the user's landing page on a social network site, respectively). The sketch processing application 250A can display additional choices in response to the user actuating a control 826. More generally, the UI view 802 can be designed in any desired manner to allow the user to associate her sketch with a resource or a group of resources.

Now referring to FIG. 7C, the sketch processing application 250A can generate a view 830 when the user chooses to associate the sketch with a new domain. In this example implementation, the user can specify a URL or an IP address via an input box 832 or 834, respectively. Once the user actuates a control 836, the sketch processing application 250A submits the sketch, the associated resource(s), and other user-selected restrictions (when applicable) to the sketch data server 202.

FIG. 7D illustrates an example view 840 which the sketch processing application 250A can generate when a user chooses to associate a sketch with a certain resource. For example, when the user associates his sketch with an email address, the sketch processing application 250A in one embodiment displays a screen 841 with radio buttons 842 to specify whether the mapping is private to the user, open to the entire public, or restricted (visible to some but not the others). In the illustrated scenario, the user selects the restricted mode. Further, the screen 841 includes an input box 844 for specifying zero, one, or multiple users with whom the mapping is shared. The input box 844 in various implementations can receive individual addresses or other user identifiers, indications of social circles, other indicators of groups, etc. Still further, the screen 841 includes an input box 846 for specifying the period of time during which the mapping is valid, and an input box 848 for specifying a geographic area within which the mapping is valid. In this example, the user specifies a zip code, but in general the user can indicate the area in any suitable manner.

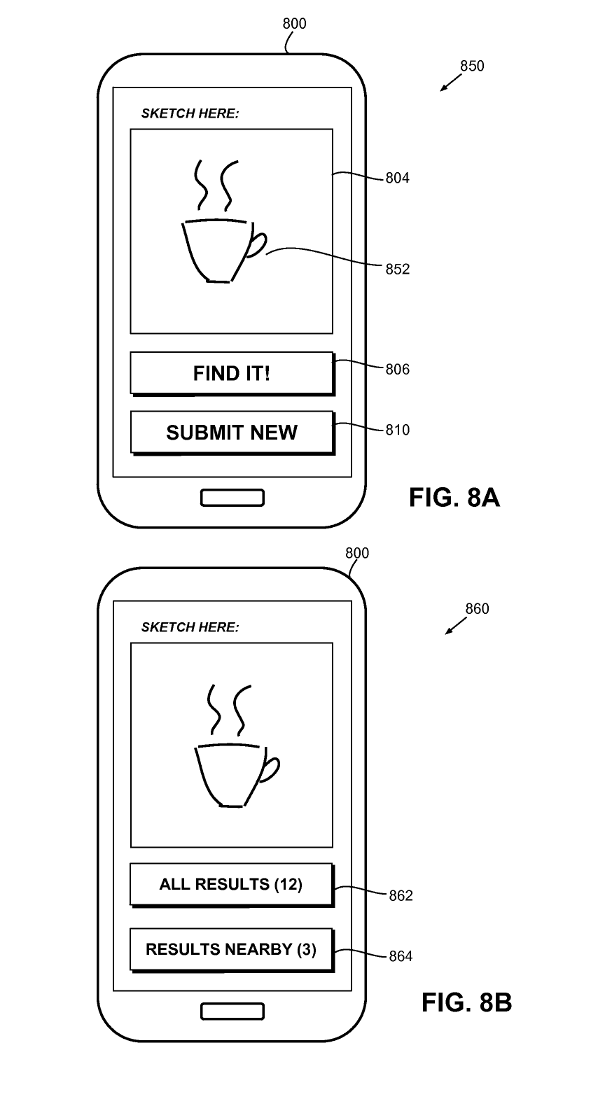

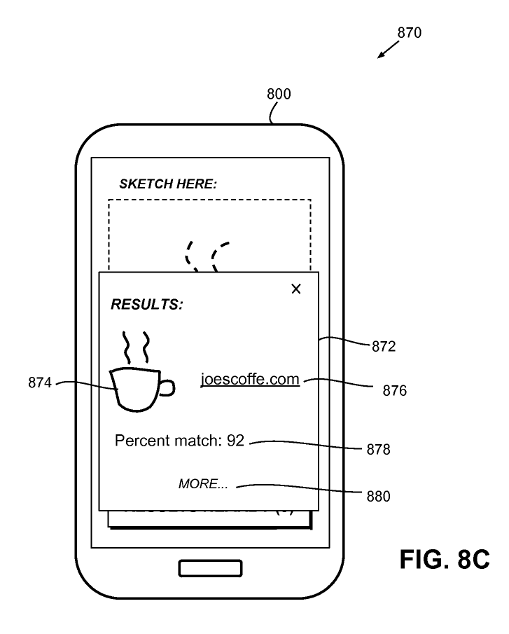

FIG. 8A illustrates a view 850 which is similar to the view 801 discussed with reference to FIG. 7A, except that this or another user tries to at least approximately recreate the sketch 805 (so as to access the resource associated with the sketch 805) and enters a sketch 852. The user then actuates the button 805 and, the user device 800 submits the sketch 852 to the sketch data server 202. In response, the sketch data server 202 provides indications of zero, one, or several at least approximate matching sketches stored in the user sketch repository 230.

FIG. 8B illustrates an example view 860 which the sketch processing application 250A can generate to indicate how many matches were found. In this example implementation, the view 860 includes a button for viewing all potentially relevant results, and a button 864 for retrieving only those results that are proximate to the current location of the user device 800. As discussed above, the sketch data server 202 can determine whether a result is relevant based on the similarity score and view of the restrictions associated with the potentially matching sketch.

Referring to FIG. 8C, the sketch processing application 250A can generate a view 870 to illustrate one of the potential matches between the sketch 852 and the sketches stored in the user sketch repository 230. In this example, the sketch data server 202 determines that the sketch 852 (see FIG. 8A) and the sketch 805 (see FIG. 7A) have a 92% match. The view 870 provides an informational card 872 that includes a miniaturized representation 874 of the sketch 805, a selectable URL 876, and a percent match indicator 878. The miniaturized representation 874 helps the user to visually inspect the proposed match and dismiss or confirm the suggested match, as necessary. If the user recognizes the sketch 805 and/or the URL 876 as the intended target, the user can click, tap, or otherwise the URL 876 to access the corresponding resource. To view another potential match, the user can actuate the control 880, for example.

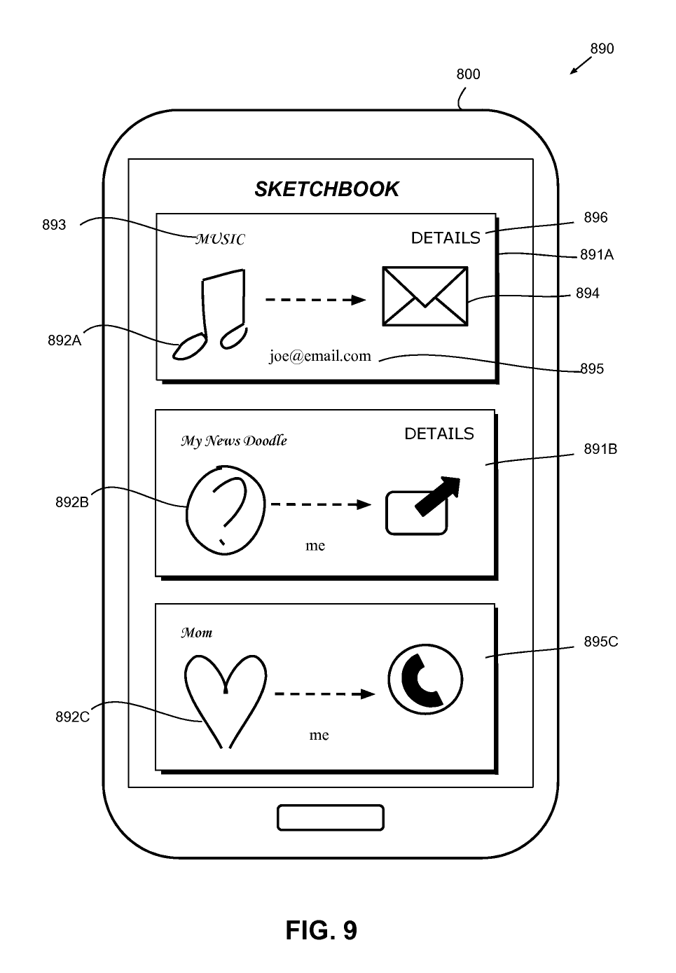

FIG. 9 illustrates an example scrollable listing 890 of available sketches and mappings, which the sketch processing application 250A can generate in response to the user activating a certain UI element. The listing 890 can include screens 891A, 891B, 891C, etc. The example screen 891A includes a miniaturization 892A of a certain sketch, a text label or description 893 assigned to the sketch, one or more icons 894 to illustrate the type of mapping, an owner/author indication 895 to inform the user of the origin of the sketch, and a details button or link 896 to request additional details regarding the sketch and the mapping.

According to the example listing 890, the sketch depicted in the screen 891A was created by another user (who chose to share the sketch and the mapping with at least one or more user), was assigned the label “music,” and was mapped to a certain email address. To see the email address, the user of the portable device 800 can operate the details buttons 896. The screen 891B indicates that the user of the device 800 previously entered own sketch (depicted as miniaturization 892B), assigned the label “my news doodle” to the sketch, and mapped the sketch to a certain URL. The screen 891C indicates that the user also entered a sketch corresponding to miniaturization 892C, assigned the label “mom,” and mapped it to a telephone number. In general, the listing 890 can include any suitable number of entries, can can be formatted in any desired manner.

### VIII. Sketches with Alphanumeric Components

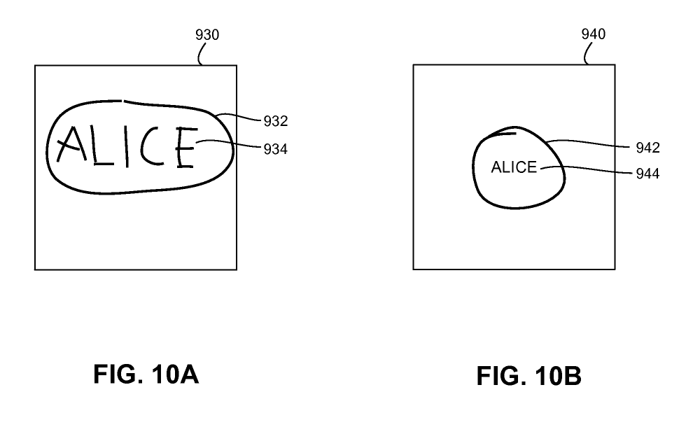

Referring to FIG. 10A, some of the embodiments of the sketch mapping system of this disclosure can support user sketches that include alphanumeric components as well as shapes that are not alphanumeric or otherwise expressible using known symbols of human writing systems. For example, a sketch 930 includes an alphanumeric string made up of “handwritten” letters 932 and an approximately oval shape 934. In one implementation, the sketch mapping system recognizes the letters 932 using any suitable symbol recognition technique and transforms the letters 932 into an ASCII string (in this case, “ALICE”). The sketch mapping system then stores a description of the shape 934, which can be based on strokes or vertices, for example, along with the ACII string. In another implementation, a sketch processing software operating in a client device (e.g., the sketch processing module 430 of FIG. 3A) recognizes the letters 932 locally, transforms these letters to an ASCII string, and generates a description of the sketch 930 that (i) includes a stroke-based, vertex-based, or another definition of the shape 934, (ii) includes the alphanumeric string “ALICE,” (iii) includes an indication of positioning of the string “ALICE” relative to the shape 934, and (iv) omits a description of the letters 932 in a non-alphanumeric format.

FIG. 10B illustrates another scenario in which a user generates a sketch 940 by typing in, rather than drawing, the string “ALICE” (string 944) and encircling the string 944 with an approximately oval shape 942. To this end, the sketch processing software operating in a client device can accept keyboard input in the drawable region and/or provide a control for switching between sketch input and keyboard input. Similar to the scenario discussed above with reference to FIG. 10A, the sketch processing software can provide a stroke-based, vertex-based, or another description of the shape 942 along with the alphanumeric string “ALICE” to the sketch data server and an indication of the positioning of the alphanumeric string relative to the shape 942.

In an embodiment, the sketch processing software operates in a web browser as a script or extension, for example, automatically detects “traditional” alphanumeric input entered via the URL bar of the browser and, upon activation of a certain control such as a button displayed next to the URL bar, and places the alphanumeric input into the drawable region. The user can then augment the alphanumeric input with a sketch. The button also can automatically launch the sketch processing software in addition, in some embodiments.

Thus, to quickly generate the combined sketch illustrated in 10B, the user can simply (i) type “alice” into the URL bar, (ii) actuate the dedicated button displayed next to the URL bar (or otherwise enter a touchscreen command, a keyboard, a voice command, etc.) to thereby launch the sketch processing software and automatically place the alphanumeric string “ALICE” in the middle of the drawable region provided by the sketch processing software, and (iii) sketch a circle around the string “ALICE.” The user then can proceed to specify the mapping for the combined sketch or request that the already-existing mapping be determined.

To specify the positioning of letters, numbers, and other symbols that have ASCII equivalence, the sketch processing software can specify a rectangular bounding box that encloses the letters, for example.

### IX. Example Methods for Processing User Sketches

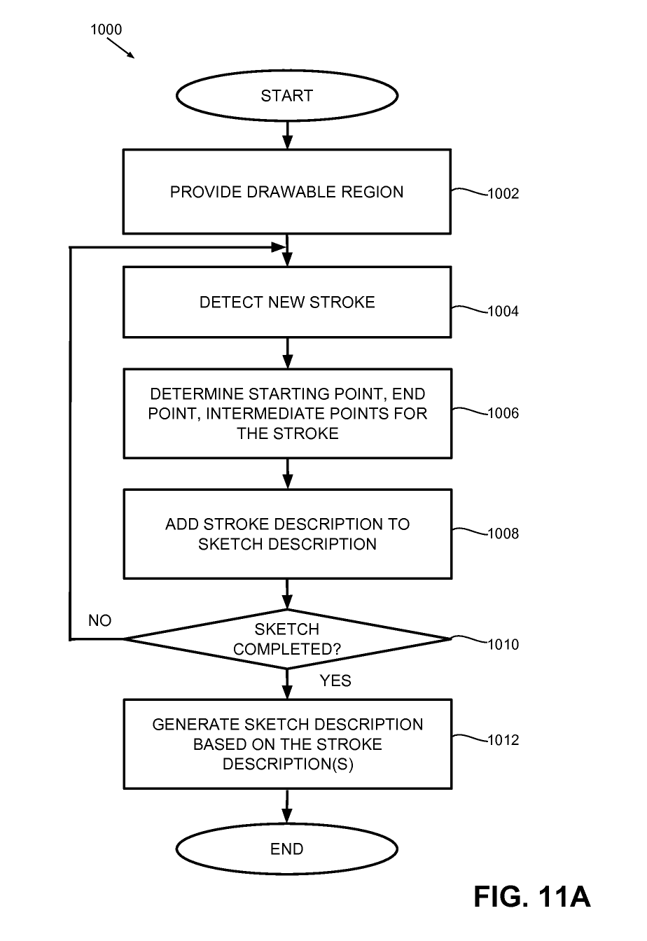

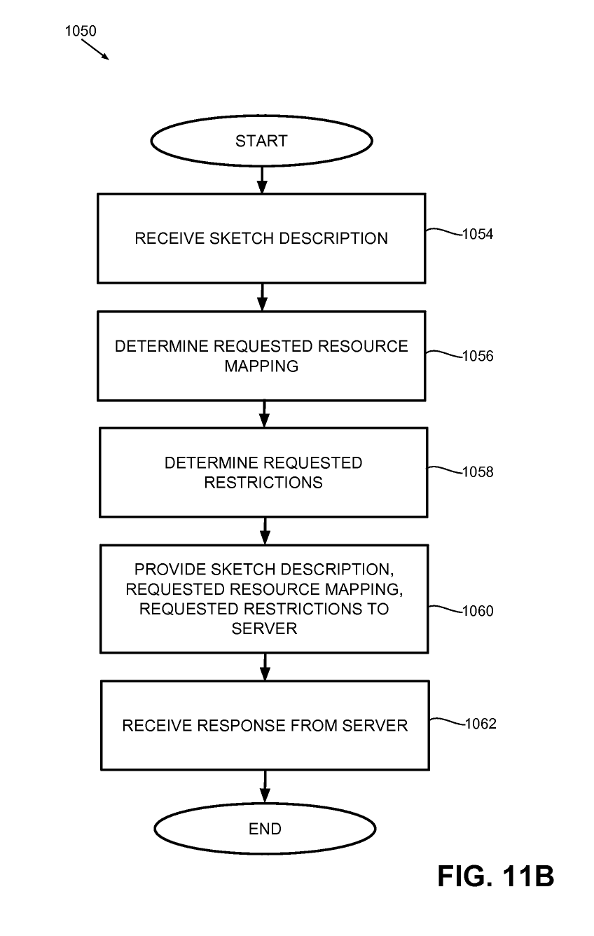

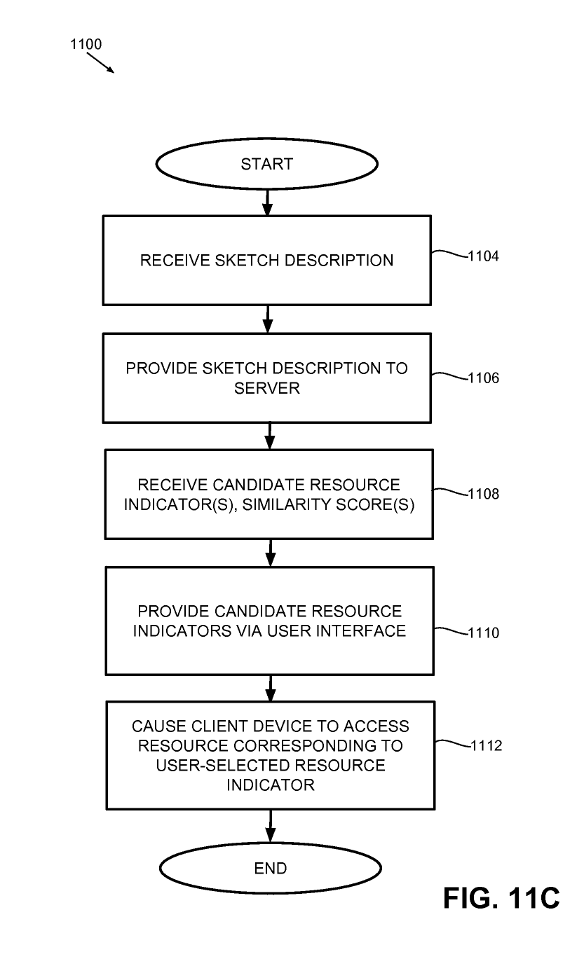

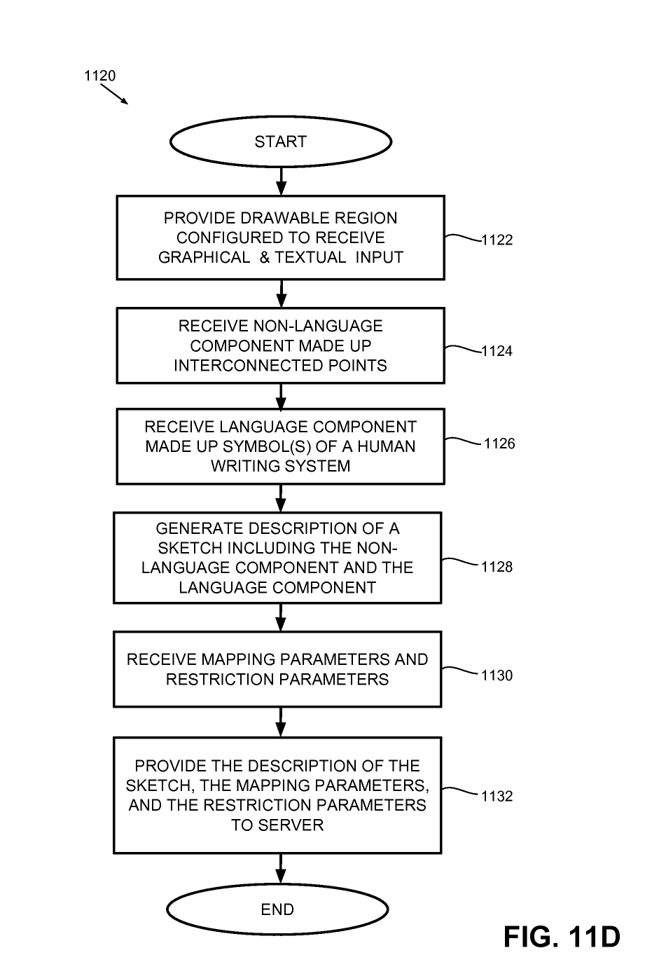

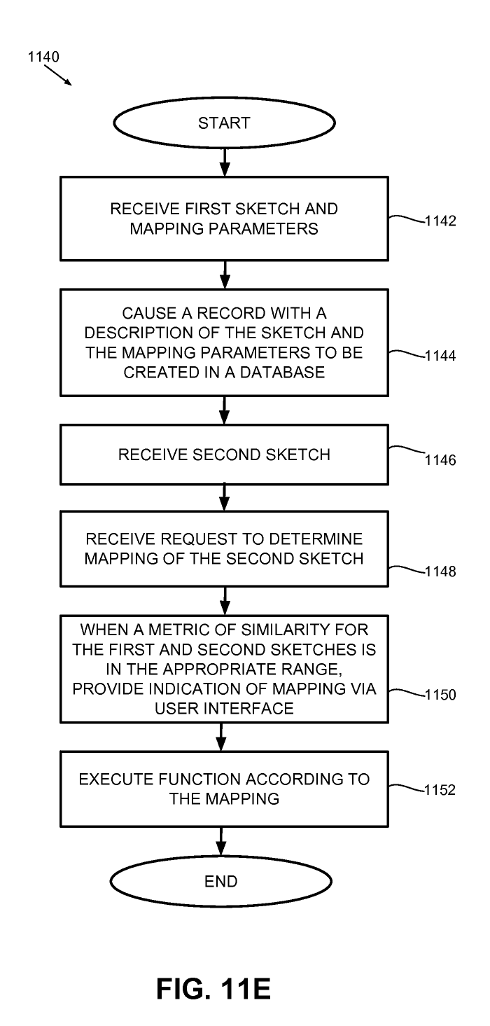

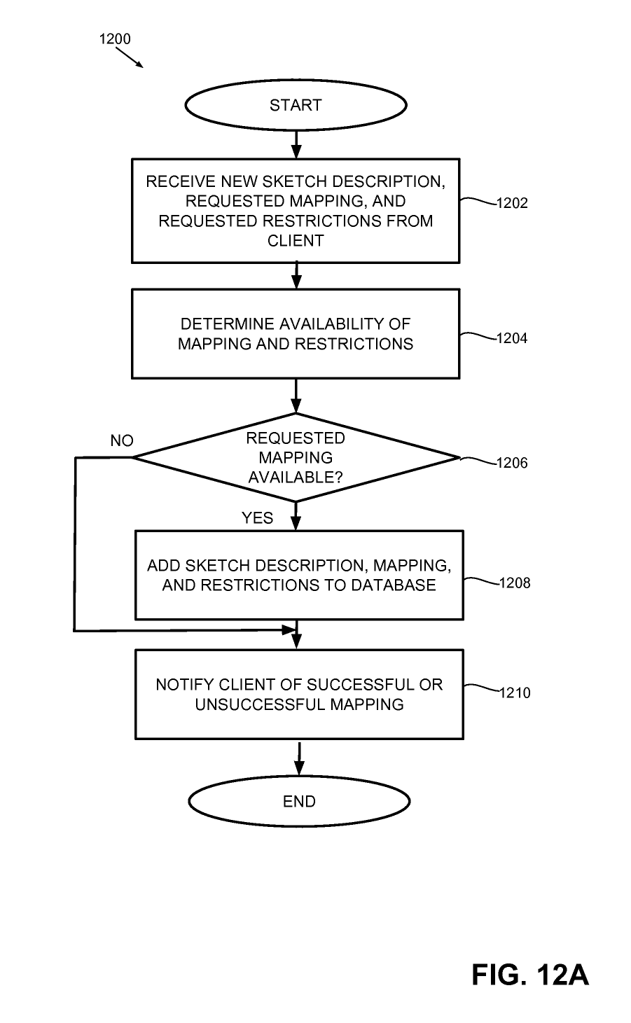

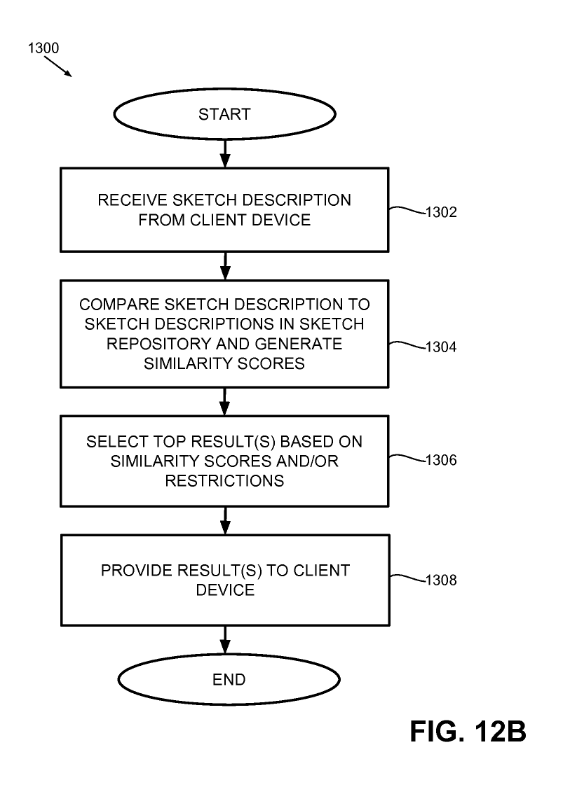

Next, several example methods are discussed next with reference to FIGS. 11A-12C. Each of these methods can be implemented as a set instructions stored on a non-transitory computer-readable medium and executed on one or more processors, one or more computing devices, etc. For example, some of these methods can be executed in a distributed manner on multiple devices of the same or different types. The instructions can include any suitable combination of compiled instructions (e.g., binary code), instructions interpreted at runtime, etc.

FIG. 11A illustrates an example method 1000 for processing a user sketch, which can be implemented in the sketch processing module 430 of FIG. 3A, the sketch processing application 502 of FIG. 3B, or a similar software module. The method 1000 begins at block 1002, where a drawable region is provided to a user via a user interface. For example, an HTML5 Canvas can be provided in a separate application, a window of a web browser, or a frame displayed by a web browser.

Strokes that make up a user sketch are detected at blocks 1004-1010. For example, if JavaScript is used, a mousedown event or a touchstart event can be be detected at block 1004 if user device is configured to receive mouse input or touch input, respectively. At block 1006, several points within the drawable region which the stroke traverses are determined. To consider touch input, for example, the starting point can correspond to the location at which the touchstart event is received, the end point can correspond to the location at which the touchend event is received, and intermediate points can correspond to at least some of the points for which the touchmove event is received.

At block 1008, the points detected at block 1006 are organized into a sequence of points in a temporary data structure, for example, and added to the description of the user sketch. If the user indicates that the sketch has been completed by actuating the “submit” button, for example (block 1010), the flow proceeds to block 1012. Otherwise, the flow returns to block 1004. At block 1012, a description of the user sketch is generated in a suitable format, such as the XML format discussed above.

FIG. 11B illustrates an example method 1050 for requesting a new mapping between a user sketch and one or more resources, which also can be implemented in the sketch processing module 430 of FIG. 3A, the sketch processing application 502 of FIG. 3B, or a similar software module. At block 1054, a sketch description is received. For example, the method 1000 discussed above can be executed. At block 1056, a requested mapping of the sketch to one or several resources is determined. For example, the UI views of FIGS. 7B and 7C can be generated to receive an indication of a type of a resource and the identifier o of the resource. Restrictions for the resource can be configured at block 1058 using the view of FIG. 7D, for example.

At block 1060, the description of the sketch, the requested mapping of the sketch to one or more resources, and the requested set of restrictions are provided to a server, such as the sketch data server 202. The response from the server in this implementation is received at block 1062. Depending on whether the user requested a mapping and a set of restrictions that do not conflict with other mappings, the server can provide a positive or a negative confirmation. For example, if the user requested that a sketch always being used exclusively by another party be associated with her resource, the server may reject the request and suggest that the user choose a different sketch.

FIG. 11C is a flow diagram of an example method 1100 for determining a mapping between a user sketch and one or more resources, which can be implemented in the sketch processing module 430 of FIG. 3A, the sketch processing application 502 of FIG. 3B, or a similar software module. The method 1100 begins at block 1054, where a description is received (e.g., by executing the method 1000 of FIG. 11A). At block 1106, the description is provided to a server, such as the sketch data server 202, via a communication network. To this end, XML or another suitable format for describing strokes and/or vertices can be used.

At block 1108, indicators for zero, one, or several candidate resources are received from the server. The descriptions can be accompanied by similarity scores to help the user assess the probability that she selects the correct resource. Further, as illustrated in FIG. 8C, for example, a complete or miniaturized version of the sketch corresponding to the candidate resource may be received to also provide visual guidance to the user during the selection process. Still further, additional information such as a brief description of the candidate resource can be received. The description in one example scenario specifies the type of business (e.g., “This is a gourmet tea shop”). In another scenario, the description indicates that this is a personal website configured to be open to the public (e.g., “This is Joe's TV and movie blog.”). In any case, this information can further help users to properly select the desired targets.

The indicators of the candidate resources are provided via a user interface along with the additional information, when available (block 1110) and, when a selection is received, the client device accesses the selected resource (block 1112). For example, an indicator of a candidate resource may be a URL. When the user taps on, clicks, or otherwise selects the URL, a web browser may be launched to access the URL.

FIG. 11D is a flow diagram of an example method 1120 for processing a user sketch that includes a first component that represents a symbol inexpressible using human writing systems and a second component that represents a symbol that can be expressed using one or more human writing systems. This method can be implemented in the sketch processing module 430 of FIG. 3A, the sketch processing application 502 of FIG. 3B, or a similar software module.

The method 1120 begins at block 1122, where a drawable region is provided for graphical and/or textual user input. As discussed above, the drawable region can be implemented as a canvas element using HTML5. At block 1124, a non-language component, inexpressible using human writing systems, is received. At block 1126, a language component, expressible as one or more symbols in one or more human writing systems, is received. A description of the sketch including these two components is generated at block 1128. The description can specify the geometry of the non-language component in terms of interconnected vertices, basic shapes, or in any other suitable manner. The description can specify the language component in terms of ASCII symbols, for example.

At block 1130, mapping and/or restriction parameters are received. Similar to the examples discussed above, the mapping parameters can specify one or more electronic resources and the corresponding command, such as accessing a web site or sending an email, and the restriction parameters can specify who can access the sketch the mapping, in what region the mapping is valid, etc. The description of the sketch and the mapping and/or restriction parameters are transmitted to a server at block 1132.

FIG. 11E is a flow diagram of an example method 1140 for receiving a first sketch along with mapping parameters in a first instance and a second sketch in a second instance, and determining a possible mapping of the second sketch to an electronic resource, which can be implemented in the client device of FIG. 3A or 3B. In particular, the first sketch and the corresponding mapping/restriction parameters are received at block 1142. A database record storing a description of the geometry of the received sketch is created at block 1144. An indication of mapping of the sketch to one or several electronic resources also can stored in the database record. Further, the database record can store indications of who can access the sketch and the mapping.

At block 1146, the second sketch is received. The second sketch can be received from the same user operating the same device used to specify the sketch at block 1142, or from the same user operating a different device, or from a different user operating another device, for example. A request to determine the mapping of the second sketch is received at block 1148. The request can be generated in response to a user operating a control such as the button 806 in FIG. 8A, for example.

Next, a module that implements the method 1140 determines a quantitative metric of similarity between the first sketch and the second sketch (in a typical scenario, the second sketch is compared to multiple sketches, not just the second sketch). When the metric of similarity is in a certain appropriate range, such as between 0 and 0.90 when the metric is indicative of an average normalized distance between the two sketches, or between 90.0% and 100.0% when the metric is indicative of a percentage match between the two sketches, the resource mapping of the first sketch is provided to the user who submitted the second sketch. The resource mapping can be provided to this user subject to additional conditions, such as the group with whom the first sketch is shared encompassing the user who submitted the second user, in the event different users submitted the first sketch and the second sketch.

At block 1152, the function specified by the mapping is executed. The function can include accessing a certain web site, invoking a mailer application with a specified email address, invoking a mapping application with a specified geographic location, placing a telephone call to a specified number, etc.

Now referring to FIG. 12A, an example method 1200 can be implemented in the new sketch registration module 620 or a similar software module, for example. At block 1202, a description of a new sketch is received from a client device along with a requested mapping and a set of requested restrictions to be applied to the mapping. At block 1204, the availability of the requested mapping is assessed. As discussed above, the requested mapping may fail because of a conflict between the request and an already existing mapping. Another example reason for rejecting the requested mapping can be a restriction associated with the requesting user (e.g., maximum number of mappings for an individual user already reached).

If the requested mapping is available (block 1206), the flow proceeds to block 1208, where the new sketch description, the mapping, and the restrictions are saved to a sketch data repository. Otherwise, the flow proceeds to block 1210. The user is notified of whether the mapping was successful or unsuccessful at block 1210. The method 1200 completes after block 1210.

FIG. 12B is a flow diagram of an example method 1300 for determining the mapping between a user sketch and one or more resources, which can be implemented in the sketch matching module 622, for example, or another suitable module.

At block 1302, a description of a sketch is received from a client device. At block 1304, the sketch is compared to the set of sketches stored in the sketch data repository. Each comparison may generate a similarity score, which can be expressed as a percentage of certainty the two sketches are the same. A certain number of top candidate resources can be selected at block 1306. This number can be configurable, user-controlled, and/or dependent on the overall number of matches that exceed a certain threshold (e.g., 75% match). The selected results are then provided to the client device at block 1308. For example, XML format can be used to describe a list of results, each including several or all of (i) an indicator of a resource such as a URL, the calculated similarity score, a miniaturized version of the sketch associated with the resource in the sketch repository, etc.

### X. Defining and Using Recognizable Sketches

As discussed above, users in general can define sketches that are highly idiosyncratic or, conversely, intuitively recognizable as representing common objects and concepts. In some cases, the operator of the sketch mapping system (e.g., of the system that includes the components 202, 204, and 230 of FIG. 2A) can define sketches for mapping to types or groups of businesses, users, etc. A user then may choose to associate her resources with one of these pre-defined or shared sketches, so that the sketch mapping system can provide her resource as part of a relatively large set of candidate resources in response to this or another user submitting a similar sketch. Additionally or alternatively, users can associate their resources with shared sketches for resolution within a specified zip code, telephone area code, a radius of a Global Positioning Service (GPS) coordinate, etc.

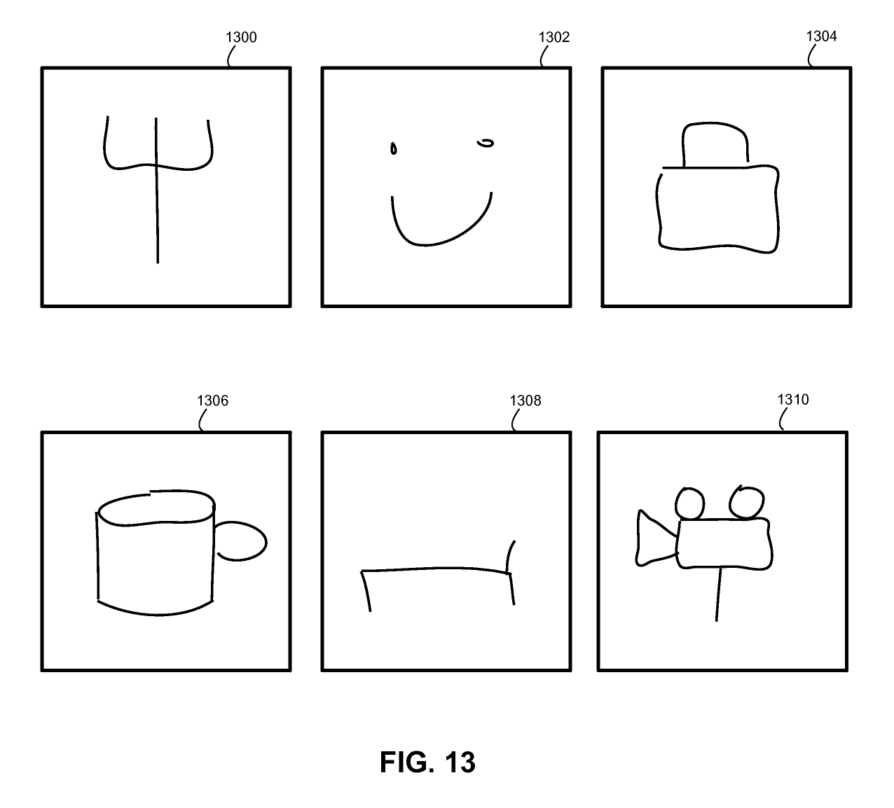

FIG. 13 illustrates several example sketches which multiple users may share according to any predefined or negotiated policy. In particular, sketch 1300 illustrates a fork which can be drawn with only two simple strokes. It is contemplated that this sketch can represent restaurants, cafes, etc. Sketch 1302 illustrates a “smiley” which is generally recognized as representing entertainment options. Sketch 1304 illustrates a bag which many users can intuitively associate with shopping. Sketch 1306 is a sketch of a cup which can be used to select coffee shops and similar places. Sketch 1308 is a simple two-stroke sketch of a bed, which can be mapped to hotels, for example. Sketch 1310 depicts a camera which can be associated with a movie theater or a particular type of a movie theater.

Further, users may wish to share some sketches as access points to categories in a hierarchy of listings. For example, a certain restaurant owner may submit two sketches: a first sketch closely resembling the fork of the sketch 1300, and a second sketch which is more idiosyncratic, such as a triangle with a circle inscribed within. The restaurant owner may request that these two sketches be associated with the specified website of the restaurant, as a sequence of sketches rather than as portions of the same sketch. The sketch mapping system accordingly can store the two sketches as portions of a “path” for accessing the website. When a potential patron of the restaurant wishes to access the website of the restaurant, she can sketch a fork first, followed by the triangle-with-a-circle sketch, and submit these as two separate drawings. Depending on the implementation, the user interface on the client device can accept these drawings sequentially (e.g., by presenting the sequence of views in FIGS. 8A-C multiple times) or in parallel (e.g., by splitting the drawable area 804 in FIG. 8A into several sections).

As indicated above, some users may be willing to share their sketches and the names they assign to the sketches with others, without also sharing the mapping to electronic resources. The system 200 or 300, for example, can use these sketches to build a database of sketches sharing the same or similar names. When several users submit respective sketches sharing the name “fish,” the system 200 or 300 can “learn” several ways in which users tend to sketch a fish and provide these sketches to other users who may be requesting suggestions.

### XI. Additional Techniques for Accessing Resources Using Non-Textual Information

In some embodiments, a drawable region similar to the drawable region 804 of FIG. 7A is provided as an overlay for an electronic document such as an email message, a web page, a digital image, etc. The user can invoke the overlay layer, enter a sketch, and associate this sketch with a certain action. This or another user then can invoke the action by reproducing the sketch (within the allowable tolerance level, as discussed above). For example, the user can sketch a star over a web page to bookmark it. As another example, the user can sketch a sad face over an email message to mark the message as spam.

Further, In some embodiments, a user can trace a 3D shape with a smartphone, and sketch processing software operating in the smartphone can generate a description of this 3D shape using techniques similar to those described above. As a more specific example, a 3D “sketch” can be described as a set of strokes, each having at least a starting point described using x, y, and z coordinates, an end point, and a set of intermediate points. As another example, the user may “point out” vertices of a 3D shape, each described using x, y, and z coordinates. The user in this case may move the smartphone in some preconfigured manner to specify a point in a 3D space.

### XII. Additional Considerations

In accordance with one aspect of the disclosure, a method for directing a user to a resource is provided. The method includes receiving a description of a sketch entered by a user via a touchscreen interface, comparing the description of a sketch to a plurality of descriptions of sketches stored in a database, identifying one or more probable matches, retrieving, for the one or more probable matches, respective identifiers of resources from the database, and providing the retrieved identifiers to the user.

In this specification, multiple instances sometimes can implement components, operations, or structures described as a single instance. Unless stated otherwise, nothing requires that individual operations of one or more methods be performed in the order illustrated. Also, at least some of the individual operations illustrated separately can be executed concurrently.

Although individual operations of one or more methods are illustrated and described as separate operations, one or more of the individual operations may be performed concurrently, and nothing requires that the operations be performed in the order illustrated. Similarly, structures and functionality illustrated as a single component may be implemented as separate components. These and other variations, modifications, additions, etc, fall within the scope of the subject matter of the present disclosure.

It is noted that the terms “comprises,” “comprising,” “includes,” “including,” “has,” “having” (or any other variations of these terms) refer to a non-exclusive inclusion. For example, a method that comprises a list of acts or steps is not necessarily limited to only those acts or steps but may include other acts or steps not expressly listed or inherent to this method. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of the indefinite articles “a” or “an” is meant to describe elements and components of the embodiments. This is done merely for convenience and to give a general sense of the description. This description should be read to include one or at least one, and the singular also includes the plural unless it is obvious that it is meant otherwise.

As used in this disclosure, a reference to “one embodiment” or “an embodiment” means that a certain element, feature, structure, or characteristic described in connection with the embodiment is included in at least one embodiment. The use of the phrase “in one embodiment” on various occasions in the specification does not necessarily refer to the same embodiment.

Some embodiments may be described using the expression “coupled” and “connected” along with their derivatives, such as “interconnected.” These terms may mean that the components are coupled directly (e.g., via an electrical contact such as a bus). However, these terms also may mean that two or more elements are not in direct contact with each other, but still co-operate or interact with each other.

Upon reading this disclosure, those of ordinary skill in the art will appreciate still further alternative structural and functional designs for mapping user sketches to resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope of this disclosure.

What is claimed is:

1. A method for mapping user sketches to electronic resources, the method comprising:
receiving, by one or more processors, (i) a first sketch defining a symbol absent from human writing systems (ii) a selection of an electronic resource to which the first sketch is to be mapped;
causing, by the one or more processors, a record to be created in an electronic database, the record specifying the mapping between the first sketch and the electronic resource;
subsequently to generating the record, receiving, by the one or more processors, a second sketch via a user interface of a client device;
determining, by the one or more processors, a metric of similarity between the first sketch and the second sketch;
when the metric corresponds to a certain range of values, providing an indication of the mapping between the first sketch and the electronic resource via the user interface of the client device; and
causing, by the one or more processors, the client device to execute a command using the electronic resource as a parameter.

2. The method of claim 1, wherein receiving the selection of the electronic resource includes receiving one of (i) a uniform resource locator (URL) of a host accessible from the client device via a communication network or (ii) an Internet Protocol (IP) address of the host, and wherein causing the client device to execute the command includes causing the client device to access the URL or the IP address.

3. The method of claim 1, wherein receiving the selection of the electronic resource includes receiving an electronic address, wherein causing the computing device to execute the command includes causing the computing device to transmit a message to the electronic address, and wherein the electronic address corresponds to one of (i) an email address, (ii) an identifier in a real-time messaging service, or (iii) a telephone number.

4. The method of claim 1, wherein receiving the selection of the electronic resource includes receiving an indication of a geographic location, and wherein causing the computing device to execute the command includes causing the computing device to retrieve a digital map of an area that includes the geographic location.

5. The method of claim 1, further comprising:
receiving, by the one or more processors, (iii) a selection of the command to be executed in response to detecting sufficient similarity between the first sketch and the second sketch,
wherein the command corresponds to one of:
(i) retrieving web content from a URL, wherein the URL is the electronic resource to which the first sketch is mapped,
(ii) transmitting a message to an email address, wherein the email address is the electronic resource to which the first sketch is mapped,
(iii) transmitting a message via a real-time messaging service to a certain user account, wherein the user account is the electronic resource to which the first sketch is mapped,
(iv) originating a phone call to a telephone number, wherein the telephone number is the electronic resource to which the first sketch is mapped, or
(v) retrieving a digital map of an area including a geographic location, wherein an identifier of the geographic location is the electronic resource to which the first sketch is mapped.

6. The method of claim 1, wherein receiving the first sketch includes receiving the first sketch from a first user, and receiving the second sketch includes receiving the second sketch from a second user operating the computing device; the method further comprising:
receiving, by the one or more processors, an indication of a group of users with whom the mapping between the first sketch and the electronic resource is to be shared; and
determining, by the one or more processors, whether the second user is included in the group;
wherein causing the computing device to execute the command is further in response to determining that the second user is included in the group, and wherein the command is not executed when the second user is not included in the group.

7. The method of claim 6, further comprising:
receiving, by the one or more processors, an indication of a geographic area within which the mapping between the first sketch and the electronic resource is to be used.

8. The method of claim 1, wherein:
receiving the first sketch includes receiving the first sketch at a network server from a first client device, via a communication network,
the client device from which the second sketch is received is a second client client operating independently of the first client device, and
receiving the second sketch from the second client device includes receiving the second sketch via the communication network.

9. A method in a client device for accessing electronic resources, the method comprising:
providing, by one or more processors, a drawable region via a user interface of the client device;
receiving, by the one or more processors, a sketch entered via the drawable region, the sketch made up of a plurality of interconnected vertices;
receiving, by the one or more processors, a request to determine a mapping of the received sketch to one or more electronic resources external to the client device;
transmitting, by the one or more processors via a communication network, a data structure specifying respective coordinates of at least several of the plurality of interconnected vertices;
receiving, by the one or more processors via the communication network, a user-specified mapping between the received sketch and an electronic resource, based at least in part on similarity between the received sketch and a previously specified sketch mapped to the electronic resource; and
executing, by the one or more processors, a command associated with the electronic resource.

10. The method of claim 9, wherein:
(i) the electronic resource is a URL, and executing the command includes retrieving web content from the URL, or
(ii) the electronic resource is an email message, and executing the command includes transmitting a message to the email address, or
(iii) the electronic resource is a user account identifier, and executing the command includes transmitting a message via a real-time messaging service to a user account corresponding to the user account identifier, or
(iv) the electronic resource is a telephone number, and executing the command includes originating a phone call to the telephone number, or
(v) the electronic resource is an indicator of a geographic location, and executing the command includes retrieving a digital map of an area including the indicated geographic location.

11. The method of claim 9, further comprising:
receiving, by the one or more processors via the communication network, a plurality of candidate matching sketches selected based at least in part on respective measurements of similarity to the sketch, each of the plurality of candidate matching sketches corresponding to a respective one of a plurality of electronic resources;
wherein identifying the electronic resource includes receiving a selection of the sketch from among the plurality of candidate matching sketches, via the user interface of the client device.

12. The method of claim 11, wherein the sketch defines a symbol inexpressible as a set of one or more symbols available in human writing systems.

13. The method of claim 11, further comprising:
receiving, by the one or more processors, user login information; and
transmitting the login information to the server along with the sketch;
wherein the received candidate matching sketches are selected further based on the login information.

14. The method of claim 9, wherein receiving the sketch includes receiving an alphanumeric component of the sketch, and wherein the similarity between similarity is based in part on the alphanumeric component.

15. The method of claim 9, further comprising providing a background image in the drawable region, against which the sketch is drawn.

16. A computing device comprising:
a user interface configured to receive graphic input;
one or more processors; and
a non-transitory computer-readable memory storing thereon instructions that, when executed on the one or more processors, cause the computing device to:
receive, from a user in a first instance, a first sketch via the user interface and a mapping of the first sketch to an electronic resource, wherein the first sketch defines a symbol absent from human writing systems, and wherein the electronic resource identifies a target outside the computing device,
receive, in a second instance, a second sketch via the user interface, and
access the target in response to determining that the second sketch is similar to the first sketch.

17. The computing device of claim 16, wherein the instructions further cause the computing device to receive, in the first instance, an indication of a group of users with whom the first sketch and the mapping of the first sketch is to be shared.

18. The computing device of claim 16, wherein the instructions further cause the computing device to receive, in the first instance, an indication of a group of users with whom the first sketch, but not the mapping of the first sketch, is to be shared.

19. The computing device of claim 16, wherein the instructions further cause the computing device to receive, in the first instance, an alphanumeric name of the sketch.

20. The computing device of claim 16, further comprising:
a network interface to couple the computing device to a server via a communication network,
wherein the instructions further cause the computing device to:
transmit a description of the second sketch to the server, the description specifying coordinates for a plurality of interconnected vertices of the sketch.
